(19) United States
(12) Patent Application Publication
(10) Pub. No.: US 2025/0089069 A1
(43) Pub. Date: Mar. 13, 2025

(54) DATA TRANSMISSION METHOD AND APPARATUS, AND TERMINAL DEVICE AND NETWORK DEVICE

(71) Applicant: GUANGDONG OPPO MOBILE TELECOMMUNICATIONS CORP., LTD., Dongguan (CN)

(72) Inventors: Zhihua SHI, Dongguan (CN); Jianfei CAO, Dongguan (CN); Yun FANG, Dongguan (CN)

(21) Appl. No.: 18/955,945

(22) Filed: Nov. 21, 2024

Related U.S. Application Data
(63) Continuation of application No. PCT/CN2022/110330, filed on Aug. 4, 2022.

(51) Int. Cl. H04W 72/232; H04B 7/06

(52) U.S. Cl. CPC H04W 72/232; H04B 7/06968

(57) ABSTRACT

A data transmission method, and a terminal device and a network device are provided. The data transmission method includes that: a terminal device determines at least one first Transmission Configuration Indicator (TCI) state for a first Physical Downlink Control Channel (PDCCH), wherein the at least one first TCI state is used for indicating Quasi Co-Location (QCL) information of at least one PDCCH candidate of a plurality of PDCCH candidates, and the plurality of PDCCH candidates are used for transmitting/repeatedly transmitting the first PDCCH; and the terminal device receives the first PDCCH based on the at least one first TCI state.

### CROSS-REFERENCE TO RELATED APPLICATION(S)

This application is a continuation of International Application No. PCT/CN2022/110330 filed on Aug. 4, 2022, the entire contents of which are hereby incorporated by reference.

### BACKGROUND

In a New Radio (NR) system, there is a scenario where multiple Transmission/reception points (TRP), multiple panels, or multiple beams simultaneously transmit downlink data to a terminal device. If the downlink transmissions come from different TRPs/panels/beams, characteristics of a transmission environment corresponding to the data transmission may also change, and a network device may inform the terminal device of corresponding channel-related information through the Transmission Configuration Indicator (TCI) state. However, at present, the unified TCI state only supports single-TRP/panel/beam. There is currently no specific method on how to perform TCI state configuration for downlink channel repetition in the scenario of the multi-TRP/panel/beam transmission.

### SUMMARY

Embodiments of the present disclosure relate to the field of mobile communication technologies, and provide data transmission methods, a terminal device, and a network device.

In a first aspect, an embodiment of the present disclosure provides a data transmission method, which includes the following operations.

A terminal device determines at least one first Transmission Configuration Indicator (TCI) state for a first Physical Downlink Control Channel (PDCCH), where the at least one first TCI state is used for indicating Quasi Co-Location (QCL) information of at least one PDCCH candidate of multiple PDCCH candidates, and the multiple PDCCH candidates are used for transmitting/repeatedly transmitting the first PDCCH.

The terminal device receives the first PDCCH based on the at least one first TCI state.

In a second aspect, an embodiment of the present disclosure provides a data transmission method, which includes the following operations.

A network device transmits, through at least one PDCCH candidate of multiple PDCCH candidates, a first PDCCH to a terminal device, where the multiple PDCCH candidates are used for transmitting or repeatedly transmitting the first PDCCH, and QCL information of the at least one PDCCH candidate is determined by at least one first TCI state for the first PDCCH.

In a third aspect, an embodiment of the present disclosure provides a terminal device, which includes a transceiver, a processor, and a memory for storing a computer program that, when executed by the processor, causes the processor to determine at least one first TCI state for a first PDCCH, where the at least one first TCI state is used for indicating QCL information of at least one PDCCH candidate of multiple PDCCH candidates, and the multiple PDCCH candidates are used for transmitting or repeatedly transmitting the first PDCCH; and receive, via the transceiver, the first PDCCH based on the at least one first TCI state.

In a fourth aspect, an embodiment of the present disclosure provides a network device, which includes a transceiver, a processor, and a memory for storing computer programs that, when executed by the processor, cause the processor to transmit, through at least one PDCCH candidate of multiple PDCCH candidates, a first PDCCH to a terminal device via the transceiver, where the multiple PDCCH candidates are used for transmitting or repeatedly transmitting the first PDCCH, and QCL information of the at least one PDCCH candidate is determined by at least one first TCI state for the first PDCCH.

### BRIEF DESCRIPTION OF THE DRAWINGS

The drawings described herein are adopted to provide a further understanding to the present disclosure and form a part of the present disclosure. Schematic embodiments of the present disclosure and descriptions thereof are adopted to explain the present disclosure and not intended to form improper limits to the present disclosure. In the drawings:

FIG. 1 is a diagram of an application scenario according to an embodiment of the present disclosure;

FIG. 2A is a schematic diagram of a multi-TRP transmission according to an embodiment of the present disclosure;

FIG. 2B is a schematic diagram of a multi-beam transmission according to an embodiment of the present disclosure;

FIG. 3 is a first flowchart of a data transmission method according to an embodiment of the present disclosure;

FIG. 4 is a first schematic structural diagram of a first Medium Access Control Control Element (MAC CE) according to an embodiment of the present disclosure;

FIG. 5 is a second schematic structural diagram of a first MAC CE according to an embodiment of the present disclosure;

FIG. 6 is a second flowchart of a data transmission method according to an embodiment of the present disclosure;

FIG. 7 is a third flowchart of a data transmission method according to an embodiment of the present disclosure;

FIG. 8 is a fourth flowchart of a data transmission method according to an embodiment of the present disclosure;

FIG. 9 is a fifth flowchart of a data transmission method according to an embodiment of the present disclosure;

FIG. 10 is a first schematic structural diagram of a data transmission apparatus according to an embodiment of the present disclosure;

FIG. 11 is a second schematic structural diagram of a data transmission apparatus according to an embodiment of the present disclosure;

FIG. 12 is a schematic structural diagram of a communication device according to an embodiment of the present disclosure;

FIG. 13 is a schematic structural diagram of a chip according to an embodiment of the present disclosure; and

FIG. 14 is a schematic block diagram of a communication system according to an embodiment of the present disclosure.

### DETAILED DESCRIPTION

The technical schemes of the embodiments of the present disclosure would be clearly and completely described in conjunction with the accompanying drawings in the embodiments of the present disclosure. It is apparent that the described embodiments are only part of the embodiments of the present disclosure, not all the embodiments. All other embodiments obtained by those of ordinary skill in the art with respect to the embodiments of the present disclosure without creative efforts all fall within the scope of protection of the present disclosure.

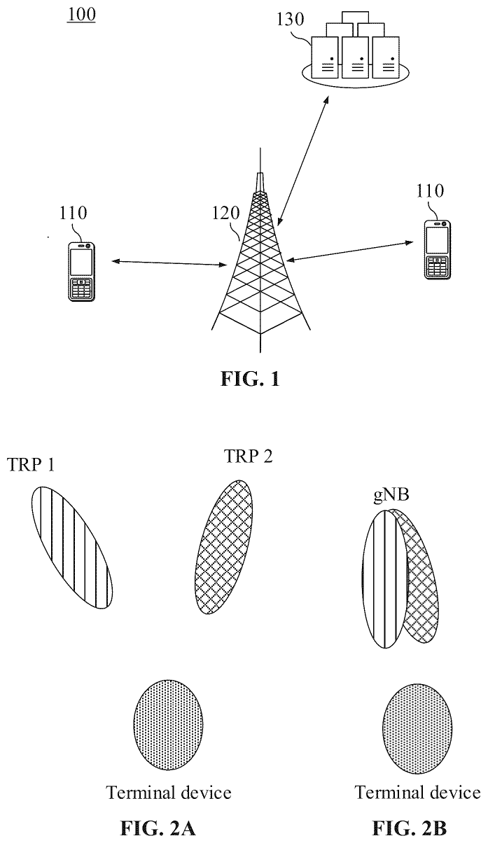

FIG. 1 is a diagram of an application scenario according to an embodiment of the present disclosure.

As illustrated in FIG. 1, a communication system 100 may include a terminal device 110 and a network device 120. The network device 120 may communicate with the terminal device 110 through an air interface. Multi-service transmission is supported between the terminal device 110 and the network device 120.

It is to be understood that the embodiments of the present disclosure are only illustrative with the communication system 100 but are not limited thereto. That is to say, the technical schemes of the embodiments of the present disclosure can be applied to various communication systems, such as a Long Term Evolution (LTE) system, a LTE Time Division Duplex (TDD), an Universal Mobile Telecommunications System (UMTS), an Internet of Things (IoT) system, a Narrow Band Internet of Things (NB-IoT) system, an Enhanced Machine-Type Communications (eMTC) system, a 5G communication system (also referred to as a New Radio (NR) communication system), or a future communication system, or the like.

In the communication system 100 illustrated in FIG. 1, the network device 120 may be an access network device that communicates with the terminal device 110. The access network device may provide communication coverage for a particular geographic area and may communicate with a terminal device 110 (such as User Equipment (UE)) located within the coverage.

The network device 120 may be an Evolved Node B (also called as eNB or eNodeB) in the LTE system, or a Next Generation Radio Access Network (NG RAN) device, or a base station (gNB) in the NR system, or a wireless controller in a Cloud Radio Access Network (CRAN); or the network device 120 may be a relay station, an access point, a vehicle-mounted device, a wearable device, a hub, a switch, a bridge, a router, or a network device in a future evolved Public Land Mobile Network (PLMN), or the like.

The terminal device 110 may be any terminal device including, but not limited to, a terminal device in wired or wireless connection with the network device 120 or other terminal devices.

For example, the terminal device 110 may be an access terminal, a UE, a subscriber unit, a subscriber station, a mobile station, a remote station, a remote terminal, a mobile device, a user terminal, a terminal, a wireless communication device, a user agent, or a user device. The access terminal may be a cellular telephone, a cordless telephone, a Session Initiation Protocol (SIP) telephone, an IoT device, a satellite handheld terminal, a Wireless Local Loop (WLL) station, a Personal Digital Assistant (PDA), a handheld device having a wireless communication function, a computing device or other processing device connected to a wireless modem, a vehicle-mounted device, a wearable device, a terminal device in a 5G network or a terminal device in a future evolution network, or the like.

The terminal device 110 may be used for the Device To Device (D2D) communication.

The wireless communication system 100 may also include a core network device 130 that communicates with the network device 120. The core network device 130 may be a 5G Core (5GC) device, for example, an Access and Mobility Management Function (AMF), for another example, an Authentication Server Function (AUSF), for another example, a User Plane Function (UPF), and for another example, a Session Management Function (SMF). Optionally, the core network device 130 may also be an Evolved Packet Core (EPC) device of the LTE network, for example, a Session Management Function+Core Packet Gateway (SMF+PGW-C) device. It is to be understood that SMF+PGW-C can implement the functions implemented by the SMF and PGW-C. In a process of network evolution, the core network device may also be called by other names, or a new network entity may be formed by partitioning the functions of the core network, which is not limited in the embodiments of the present disclosure.

The communication between the functional units of the communication system 100 may be implemented by establishing a connection through a next generation (NG) interface.

For example, the terminal device sets up the air interface connection with the access network device through a NR interface, to transmit user plane data and control plane signaling. The terminal device may set up a control plane signaling connection with an AMF through an NG interface 1 (abbreviated as N1). The access network device, such as the gNB, may set up a user plane data connection with an UPF through an NG interface 3 (abbreviated as N3). The access network device may set up control plane signaling connection with the AMF through a NG interface 2 (abbreviated as N2). The UPF may set up the control plane signaling connection with an SMF through a NG interface 4 (abbreviated as N4). The UPF may interact user plane data with a data network through a NG interface 6 (abbreviated as N6). The AMF may set up the control plane signaling connection with the SMF through a NG interface 11 (abbreviated as N11). The SMF may set up the control plane signaling connection with a PCF through a NG Interface 7 (abbreviated as N7).

FIG. 1 exemplarily illustrates one network device, one core network device and two terminal devices. Optionally, the wireless communication system 100 may include multiple network devices and other numbers of the terminal devices may be included within the coverage of each network device, which is not limited in the embodiments of the present disclosure

It is to be noted that FIG. 1 only illustrates by way of example the system to which the present disclosure applies, and of course the method shown in the embodiment of the present disclosure may also be applied to other systems. In addition, the terms “system” and “network” herein are often used interchangeably herein. In this disclosure, the term “and/or” is only to describe an association relationship between associated objects and represents that three kinds of relationships may exist. For example, A and/or B may represent three situations: i.e., independent existence of A, existence of both A and B and independent existence of B. In addition, the character “/” in the present disclosure generally indicates that the associated objects before and after this character is in an “or” relationship. It is to be understood that the reference to “indication” in the embodiments of the present disclosure may be a direct indication, may be an indirect indication, or may be indicative of an association. For example, A indicates B, which may mean that A directly indicates B, for example, B may be obtained through A; it may also mean that A indirectly indicates B, for example, A indicates C, and B may be obtained by C; or it may also indicate that there is an association between A and B. It should also be understood that the term “correspondence” may mean that there is a direct correspondence or an indirect correspondence between the two, may also mean that there is an association relationship between the two, or may also be a relationship between indication and being indicated, configuration and being configured, or the like. It should also be understood that “predefined/predefinition” or “predefined rules” may be achieved by pre-storing corresponding codes, tables or other means used for indicating relevant information in devices (e.g., including terminal devices and network devices), and the present disclosure is not limited to the specific implementation thereof. For example, predefined/predefinition may refer to what is defined in the protocol. It should also be understood that in the embodiments of the present disclosure, the “protocol” may be a standard protocol in the communication field. For example, the protocol may include an LTE protocol, an NR protocol, and related protocols applied in future communication systems, which are not limited in the present disclosure.

In order to facilitate understanding of the technical schemes of the embodiments of the present disclosure, the related technologies for the embodiments of the present disclosure are described below, and the following related technologies, as optional schemes, can be arbitrarily combined with the technical schemes of the embodiments of the present disclosure, all of which belong to the protection scope of the embodiments of the present disclosure.

### 1. Multi-Beam System.

The design goals of the 5G/NR system include large bandwidth communication in high band (such as the band above 6 GHZ). When the operating frequency becomes higher, the path loss in the transmission procedure will increase, thus affecting the coverage capability of the high-frequency system. In order to effectively ensure the coverage of the high-frequency 5G/NR system, an effective technical scheme is to adopt an massive Multiple Input Multiple Output (MIMO)-based multi-beam transmission technology to improve the coverage capability.

In the existing cellular network system (such as the 2G/3G/4G network), a cell (sector) uses a wider beam to cover the whole cell. Therefore, at each moment, a terminal device within the coverage of the cell has an opportunity to obtain a transmission resource allocated by the system.

According to the multi-beam technology in the 5G/NR, the whole cell is covered through different beams, i.e., each beam covers a smaller coverage, and an effect of multiple beams covering the whole cell is achieved through temporal sweeping. At present, different beams are identified by the different signals carried through them.

For example, different Synchronization Signal/PBCH Blocks (SSBs) are transmitted on different beams, and the terminal device may identify different beams through different SSBs. Optionally, different Channel State Information Reference Signals (CSI-RSs) are transmitted on different beams, and the terminal device may identify different beams through the CSI-RSs or CSI-RS resources.

In the multi-beam transmission scenario, a Physical Downlink Control Channel (PDCCH) and a Physical Downlink Shared Channel (PDSCH) may be transmitted through different downlink Transmission (TX) beams.

For the non-millimeter wave (such as the 2G/3G/4G) system, the terminal device generally does not have analog beams. Therefore, the terminal device uses the omnidirectional antenna (or near-omnidirectional antenna) to receive signals transmitted by the base station through different downlink TX beams.

For the millimeter wave system, the terminal device may have analog beams. In this case, the terminal device needs to use downlink reception (RX) beams to receive signals transmitted by downlink TX beams corresponding to the downlink RX beams. Therefore, corresponding beam indication is required to assist the terminal device in determining TX beam related information of the network device or corresponding RX beam related information of the terminal device.

In the NR system, the beam indication does not directly indicate the beam itself, but performs the indication by QCL information between signals. The terminal device may determine to receive the corresponding channel/signal based on the QCL information (which may also be referred to as a QCL hypothesis). When the network device transmits the downlink control channel or data channel, the network device may inform the terminal device of the corresponding QCL information through a TCI state.

### 2. Multi-TRP Transmission, Multi-Panel Transmission or Multi-Beam Transmission.

The multi-TRP transmission (mTRP transmission or M-TRP transmission) means that multiple TRPs may simultaneously communicate with the terminal device on the same carrier. The multi-beam transmission also means that using multiple beams to simultaneously communicate with the terminal device on the same carrier. Exemplarily, with reference to FIG. 2A, in the multi-TRP transmission, multiple TRPs (only TRP1 and TRP2 are illustrated in FIG. 2A) may perform the transmissions with the terminal device using independent beams, respectively. With reference to FIG. 2B, in the multi-beam transmission, the base station may communicate with the terminal device through different beams.

It is to be noted that in the NR system, the same scheme may be adopted for the multi-TRP transmission, the multi-panel transmission, or the multi-beam transmission when performing simultaneous transmission with one terminal. Therefore, the above concepts are not distinguished in the embodiments of the present disclosure, and are collectively referred to as multi-TRP/panel/beam.

In the NR system, there are two schemes for transmitting downlink data to the terminal device simultaneously using the multi-TRP/panel/beam.

A first scheme is a single-PDCCH based scheme. Specifically, the terminal device monitors only one PDCCH, and one DCI in the PDCCH indicates related indication information of data simultaneously transmitted on multiple TRPs/panels/beams.

It is to be noted that in the communication system, data transmitted on the multiple TRPs/panels/beams is implicitly indicated by using multiple TCI states.

A second scheme is a multiple-PDCCH based scheme. Specifically, the terminal device receives different PDCCHs from different TRPs/panels/beams, and the DCI monitored on each PDCCH indicates related indication information of a corresponding data transmission.

It is to be noted that a Control Resource Set (CORESET) corresponding to each DCI may be associated with a different CORESET pool index. That is to say, the DCI implicitly supports the multi-TRP/panel/beam transmission through multiple different CORESET pool indexes.

It is to be understood that in the first scheme, the terminal device needs to monitor only one PDCCH, so the complexity of the control channel monitoring may be lower than that in the second scheme. However, in the first scheme, different panels/TRPs/beams are required to quickly exchange information with each other. In the second scheme, the terminal device needs to simultaneously monitor multiple PDCCHs on the same carrier, which may increase the complexity, but may improve the flexibility and robustness.

Optionally, the scenario to which the second scheme may be applied may include at least one of a scenario 1, a scenario 2, a scenario 3, or a scenario 4.

In the scenario 1, multiple TRPs belong to the same cell, and the backhaul between the TRPs is ideal (i.e., information interaction may be performed quickly and dynamically).

In the scenario 2, multiple TRPs belong to the same cell, and the backhaul between the TRPs is non-ideal (i.e., TRPs cannot quickly exchange information with each other and can only perform relatively slow data interaction).

In the scenario 3, multiple TRPs belong to different cells, and the backhaul between the TRPs is ideal.

In the scenario 4, multiple TRPs belong to different cells, and the backhaul between the TRPs is non-ideal.

It is to be understood that by replacing the TRP in the scenario 1 to scenario 4 with the beam, then four application scenarios for the multi-beam may be obtained correspondingly.

The first scheme is only applicable to the scenarios of the ideal backhaul (such as the above scenario 1 and scenario 3).

In the Release 16 (i.e., R16) discussed in the standard, only the multi-TRP transmission for downlink data transmission is studied and supported. In the R17, the multi-TRP transmissions for PDCCH, Physical Uplink Shared Channel (PUSCH), and Physical Uplink Control Channel (PUCCH) are studied and supported to increase the reliability of corresponding channel transmissions.

In the R15 and R16, time-frequency resources for PDCCH are defined by a search space and a CORESET associated with the search space, where a TCI state for the PDCCH transmission is determined by a TCI state for the CORESET. The higher layer signaling defines one or more TCI states for each CORESET. When the higher layer signaling defines multiple TCI states for each CORESET, at any moment, the MAC layer signaling activates one of the TCI states for transmissions of PDCCHs in all search spaces associated with the CORESET. That is to say, in the existing specification, the PDCCHs defined by each search space are transmitted by a unique TCI state for the CORESET associated with the search space. Since a link may be blocked when PDCCH is transmitted through only one TCI state, which leads to that the PDCCH cannot be monitored correctly, in order to improve the reliability of the PDCCH transmission, the PDCCH transmission being performed through different TRPs is studied in the R17.

In order to support the PDCCH multi-TRP transmission, when PDCCH is transmitted through two TCI states, how to transmit the PDCCH through the two TCI states. The scheme adopted by the 3rd Generation Partnership Project (3GPP) is to link two search spaces, each of the two search spaces is associated with one of the TCI states in the CORESET, and each search space contains a set of PDCCH candidates. The PDCCH candidates (or DCIs) on the two linked search spaces are used for transmitting the same scheduling information, for example, scheduling the same uplink transmission or scheduling the same downlink transmission.

It is to be noted that for the multi-TRP system, the transmission schemes described above are all for the case of the same carrier. For example, for the multiple-PDCCH based scheme, the terminal device monitors multiple DCIs (two DCIs are supported by the existing protocol) on the same carrier, where each DCI may schedule a corresponding PDSCH, and the multiple PDSCHs are also on the same carrier. For another example, in the PDCCH multi-TRP transmission, the PDCCH candidates in two linked search spaces are both transmitted and received on the same carrier.

### 3. TCI State.

When the terminal device performs signal reception, in order to improve the reception performance, the characteristics of the transmission environment corresponding to the data transmission can be utilized to improve a reception algorithm. For example, a statistical characteristic of a channel may be utilized to optimize a design and parameters of a channel estimator. In the NR system, these characteristics corresponding to the data transmission are represented by QCL information (QCL-Info).

It is to be understood that a TCI state may include: a TCI state Identifier (ID), QCL-Info 1, and QCL-Info 2. The QCL-Info 2 is optional. In addition, a piece of QCL-Info may include: a QCL type configuration and a QCL reference signal configuration. The QCL type configuration may be one of a QCL typeA, a QCL typeB, a QCL typeC, or a QCL typeD, and the QCL reference signal configuration may be: a cell ID, a Bandwidth Part (BWP) ID, and a reference signal ID (e.g., a CSI-RS resource ID or an SSB index).

Herein, different QCL types are defined as follows. The QCL TypeA is used for configuring {Doppler shift, Doppler spread, average delay, delay spread}; the QCL typeB is used for configuring {Doppler shift, Doppler spread}; the QCL typeC is used for configuring {Doppler shift, average delay}; and the QCL typeD is used for configuring {Spatial Rx parameter}.

Optionally, the network device may indicate a corresponding TCI state for a downlink signal (or referred to as a downlink channel).

If the QCL reference signal configuration indicated by the network device for a target downlink signal (or a target downlink channel) through the TCI state is an SSB 1 resource or CSI-RS 1 resource and the QCL type configuration is the typeA, typeB, or typeC, then, the terminal device may assume that a large-scale parameter of the target downlink signal is identical or similar to the large-scale parameter of the SSB 1 resource or CSI-RS 1 resource, and the large-scale parameter is determined by the QCL type configuration.

If the QCL reference signal configuration indicated by the network device for the target downlink signal (or the target downlink channel) through the TCI state is an SSB 2 resource or CSI-RS 2 resource and the QCL type configuration is the typeD, then, the terminal device may receive the target downlink signal by using a spatial Rx parameter same as that of receiving the SSB 2 resource or CSI-RS 2 resource. Generally, the target downlink signal (or the target downlink channel) and the SSB 2 or CSI-RS 2 resource are transmitted by the same TRP, or the same panel, or the same beam at the network device side.

It is to be understood that if the transmission TRPs, the transmission panels, or the TX beams for two downlink signals (downlink channels) are different, different TCI states are usually configured.

For the downlink control channel, the TCI state may be indicated through a Radio Resource Control (RRC) signaling or through a RRC signaling plus a MAC signaling.

For the downlink data channel, a set of TCI states is indicated by a RRC signaling, and a part of the TCI states are activated by a MAC layer signaling, and finally one or two TCI states among the activated TCI states are indicated by a TCI indication field in a DCI, for the PDSCH scheduled by the DCI.

### 4. Unified TCI State.

The TCI state above is only applicable to the downlink channel and downlink signal, and there are many limitations when the TCI state above is applied in the NR system. In order to provide a more unified uplink and downlink beam management mechanism for the NR system, on the basis of the above technologies, the 3GPP organization proposed a concept of unified TCI state. Specifically, two modes of the unified TCI state are designed.

In a first mode, one category of TCI state is contained, which may be applied to uplink and downlink channels and signals, and this category of TCI state is commonly referred to as a joint TCI state.

In a second mode, two categories of TCI states including DL TCI state and UL TCI state are contained. The DL TCI state is only applicable to the downlink channels and downlink signals; and the UL TCI state is only applicable to the uplink channels and uplink signals. These categories of TCI states may be referred to as separate TCI states. The network may configure only one of the two categories of TCI states, for example, the network may configure only the DL TCI state or only the UL TCI state. The network may also simultaneously configure these two categories of TCI states, for example, the network simultaneously configures the DL TCI state and the UL TCI state.

It is to be understood that the DL TCI state or the joint TCI state may be used for indicating corresponding transmission of a downlink channel (partial PDCCH, PDSCH) and a downlink signal (aperiodic CSI-RS). The UL TCI state or the joint TCI state is used for indicating uplink transmission of an uplink channel (e.g., PUCCH, PUSCH) and an uplink signal (SRS), e.g., indicating a spatial domain filter corresponding to the uplink transmission.

Optionally, the unified TCI state may be dynamically updated and indicated by using an MAC CE and/or a DCI.

It is to be noted that the unified TCI state is applicable to a scenario of carrier aggregation (CA), and TCI state configuration and/or indication on a single Component Carrier (CC) may be applicable to multiple different CCs.

The CORESET on each CC can be classified into the four types including CORESET A, CORESET B, CORESET C and CORESET 0.

The CORESET A is only associated with a UE-specific search space, so the CORESET A may be considered as a UE-specific downlink control channel resource, and must follow the indicated unified TCI state(s).

The CORESET B is only associated with a cell-common search space. Whether the CORESET B can follow the unified TCI state(s) indicated by the network is required to be determined according to an RRC configuration of the network.

The CORESET C is associated with the UE-specific search space and the cell-common search space. Whether the CORESET C can follow the unified TCI state(s) indicated by the network is required to be determined according to the RRC configuration of the network.

The CORESET 0 is associated with the cell-common search space, and may simultaneously be associated with the UE-specific search space. Whether the CORESET 0 can follow the unified TCI state(s) indicated by the network is required to be determined according to the RRC configuration of the network.

It is be noted that the TCI state mentioned in the embodiments of the present disclosure includes any one of the aforementioned TCI states unless it is explicitly specified which TCI state it is. That is to say, the TCI state may be the joint TCI state, the separate TCI state, the DL TCI state, the UL TCI state, or a combination of them (i.e. containing multiple different categories of TCI states). In practical applications, if the RRC parameter “TCI-State” is used for configuration, it generally is the DL TCI state and/or the joint TCI state. If the RRC parameter “DLorJointTCIState” is used for configuration, it generally is the DL TCI state and/or joint TCI state. If the RRC parameter “UL-TCIState” or “TCI-UL-State” or “UL-TCI-State” is used for configuration, it generally is the UL TCI state.

### 5. PDCCH.

The network device indicates transmission of a PDCCH by configuring a CORESET and a search space.

The CORESET includes multiple physical resource blocks in the frequency domain, and includes 1 to 3 time-domain symbols in the time domain. Time-domain resources occupied by the CORESET are configured semi-statically by higher layer parameters.

In addition, the search space is a set of PDCCH candidates at one or more aggregation levels. The aggregation level of the PDCCH actually transmitted by the network device (such as a base station) can vary, and since there is no related signaling to inform the terminal device of the aggregation level of the PDCCH, the terminal device needs to blindly detects the PDCCH at different aggregation levels. The PDCCH to be blindly detected is referred to as the PDCCH candidate. The terminal device decodes the PDCCH candidate in the search space, and if the Cyclic Redundancy Check (CRC) is successful, the terminal device considers that the content of the decoded PDCCH is valid for the terminal device, and performs subsequent operations by using the information obtained through decoding.

It is to be noted that a search space may also be referred to as a search space set, and the search space and the search space set are the same concept.

In the NR system, within each downlink BWP of each serving cell, the network device may configure at most 10 search spaces for the terminal device, and the search spaces are configured with time-domain configuration information for indicating the time-domain position where the terminal device monitors the PDCCH. Moreover, the network device configures an associated CORESET ID for each search space, and the terminal device may obtain physical resources of the search space in the frequency domain through the CORESET ID. Each search space set has a uniquely associated CORESET ID. Different search space sets may be associated with the same CORESET ID. The terminal device determines time-frequency domain positions of the PDCCH candidates based on the time domain information given by the search space set, the frequency domain information from the associated CORESET ID, and other parameters in the search space set.

When configuring the CORESET, the network device configures one TCI state or a group of TCI states for each CORESET. The TCI state(s) are used for indicating related parameters required by the terminal device when demodulating and monitoring the PDCCH candidates in the search spaces associated with the CORESET. When the network device configures a group of TCI states for a certain CORESET, the network device activates one TCI state for the CORESET through a MAC CE signaling to assist the terminal device in demodulating the PDCCH.

In addition, the network device may also configure, for each CORESET, a high layer indication (i.e., the CORESET pool index, also referred to as coresetPoolIndex in the RRC parameter) for indicating whether it pertains to the same TRP. The value of the high layer indication has a range of 0 and 1. For CORESETs configured with the same CORESET pool index, the terminal device may consider that data corresponding to the CORESETs originates from the same TRP.

The unified TCI state in the R17 only supports the single-TRP/panel/beam scenario. For a PDCCH repetition in the multi-TRP/panel/beam transmission system, there is still a lack of complete solutions and specific details on how to configure and indicate the unified TCI state.

In order to facilitate understanding of the technical schemes of the embodiments of the present disclosure, the technical schemes of the present disclosure will be described in detail below by way of specific embodiments. The above related technologies, as optional schemes, may be arbitrarily combined with the technical schemes of the embodiments of the present disclosure, and all of these combinations belong to the protection scope of the embodiments of the present disclosure. The embodiments of the present disclosure include at least some of following contents.

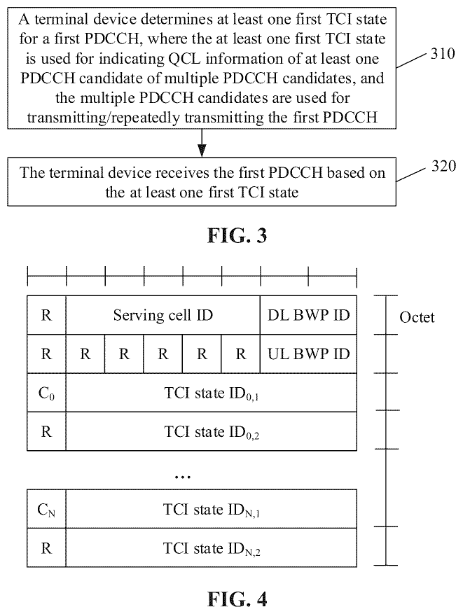

FIG. 3 is a first flowchart of a data transmission method according to an embodiment of the present disclosure. As illustrated in FIG. 3, the method includes following contents.

In operation 310, a terminal device determines at least one first TCI state for a first PDCCH, where the at least one first TCI state is used for indicating QCL information of at least one PDCCH candidate of multiple PDCCH candidates, and the multiple PDCCH candidates are used for transmitting/repeatedly transmitting the first PDCCH.

In operation 320, the terminal device receives the first PDCCH based on the at least one first TCI state.

In the embodiment of the present disclosure, the at least one first TCI state may be active unified TCI state(s) or applied unified TCI state(s). The at least one first TCI state may be configured by a network device.

It is to be understood that, When receiving/monitoring the first PDCCH, the terminal device may firstly determine, based on at least one first TCI state, the QCL information of at least one PDCCH candidate of multiple PDCCH candidates for transmitting the first PDCCH, and then, the terminal device receives the first PDCCH based on the QCL information of the at least one PDCCH candidate.

Optionally, when the number of the first TCI states configured by the network device is 1, the terminal device may receive/monitor one PDCCH candidate based on the configured one first TCI state to obtain the first PDCCH (i.e., repetition is not performed); or the terminal device may determine QCL information of each PDCCH candidate among the multiple PDCCH candidates based on the configured one first TCI state, and receive/monitor the multiple PDCCH candidates to obtain the first PDCCH (repetition is still performed). It is to be noted that, when the number of the first TCI states is 1, which of the above two manners the terminal device uses may be predefined or configured by the network device, which is not limited in the embodiments of the present disclosure.

In addition, when the number of first TCI states configured by the network device is multiple, the terminal device may determine QCL information of each PDCCH candidate among the multiple PDCCH candidates based on each of the configured first TCI states, and receive/monitor the multiple PDCCH candidates to obtain the first PDCCH.

It is to be noted that the multiple PDCCH candidates may come from different search spaces and the multiple PDCCH candidates are used for transmitting the same scheduling information, which corresponds to the PDCCH repetition in the scenario of the multi-TRP/panel/beam transmission.

In summary, according to the data transmission method provided by the embodiment of the present disclosure, when receiving/monitoring the first PDCCH, the terminal device may firstly determine, based on at least one first TCI state, the QCL information of at least one PDCCH candidate of multiple PDCCH candidates for transmitting the first PDCCH, and then, the terminal device receives the first PDCCH based on the QCL information of the at least one PDCCH candidate. That is to say, the terminal device may determine the QCL of at least one PDCCH candidate for transmission/repetition based on one or more first TCI states, and obtain the first PDCCH based on the at least one PDCCH candidate, thereby ensuring correct transmission of the first PDCCH.

The configuration and determination method of at least one first TCI state are described in detail below.

Optionally, the terminal device may receive search space linking indication information transmitted by the network device. The search space linking indication information indicates linking of multiple search spaces, and the multiple search spaces are in the same BWP.

It is to be understood that the linked multiple search spaces may be used for PDCCH repetition.

The multiple PDCCH candidates mentioned in the embodiments of the present disclosure are PDCCH candidates in multiple search spaces, respectively. The reception of the first PDCCH may include the multiple PDCCH candidates in the multiple search spaces described above. That is to say, the multiple PDCCH candidates may be used for transmitting/repeatedly transmitting the first PDCCH.

It is to be understood that the PDCCH candidates corresponding to the multiple search spaces are used for transmitting the same scheduling information (or transmitting the same DCI). For example, the multiple PDCCH candidates schedule the same uplink transmission or the same downlink transmission.

Optionally, the search space linking indication information may be carried through a RRC signaling or a MAC CE signaling, which is not limited in the embodiments of the present disclosure.

Optionally, the search space linking indication information may be carried through configuration information of any one of the multiple search spaces, and the configuration information may indicate other search spaces linked with the current search space.

Exemplarily, if a first search space is required to be linked with a second search space, one piece of search space linking indication information may be contained in the configuration information of the first search space, and the second search space may be indicated by the piece of search space linking indication information. Optionally, there is another piece of search space linking indication information contained in the configuration information of the second search space, and the first search space is indicated by the another piece of search space linking indication information.

Exemplarily, the search space linking indication information is indicated by an information field “searchSpaceLinking” or an information field “searchSpaceLinkingId” in the RRC signaling. The value of the search space linking indication information may be a positive integer from 0 to 39 (including 0 and 39), and different values are used for indicating different search spaces.

Optionally, the number of pieces of search space linking indication information may include multiple, and the multiple pieces of search space linking indication information may be one-to-one correspondences with multiple search spaces configured by the network device. The configuration information of each search space can carry a piece of search space linking indication information, and pieces of search space linking indication information of the search spaces linked with each other have the same value.

Exemplarily, the search space linking indication information is indicated through an information field “searchSpaceLinking” or an information field “searchSpaceLinkingId” in the RRC signaling. The value of the search space linking indication information may be a positive integer from 0 to 39 (including 0 and 39), and pieces of search space linking indication information of the search spaces linked with each other have the same value.

Optionally, the multiple search spaces have the same type. For example, the multiple search spaces are all Common Search Spaces (CSS) or all UE-Specific Search Spaces (USS), which is not limited in the embodiments of the present disclosure.

Optionally, the multiple search spaces may have the same DCI formats to monitor. For example, the DCI formats of the multiple search spaces may all be: DCI format 0_1, DCI format 0_2, DCI format 1_1, DCI format 1_2, or other formats, which is not limited in the embodiments of the present disclosure.

Optionally, the multiple search spaces may satisfy part of or all of the following fourth conditions.

For a condition 1, any one of the multiple search spaces is not linked with other search spaces (linking herein specifically refers to the linking among the multiple search spaces), or the terminal device does not expect any one of the multiple search spaces to be linked with other search spaces.

For a condition 2, if the PDCCH repetition is in one time-domain unit (for example, a slot, a half slot, or a set of multiple time-domain symbols), the multiple search spaces have the same periodicity and/or the same offset, or the multiple search spaces occupy the same number of time-domain symbols (i.e., the multiple search spaces have the same duration), or the multiple search spaces have the same number of PDCCH monitoring occasions within a time-domain unit (i.e., the same number of Monitoring Occasions within a slot). Exemplarily, the network device may set the same value for the RRC information field “monitoringSlotPeriodicityAndOffset” in the configuration information of each of the multiple search spaces, to indicate that the multiple search spaces have the same periodicity or offset.

For a condition 3, the multiple search spaces do not belong to the following types: a search space 0, a search space searchSpaceSIB1 for searching system information block 1, a search space searchSpaceOtherSystemInformation for searching other system information, a search space pagingSearchSpace for searching paging messages, a search space ra-SearchSpace for random access, a search space searchSpaceBroadcast for searching broadcast information, a search space peiSearchSpace, and a search space sdt-SearchSpace.

For a condition 4, the multiple search spaces are not indicated by the parameter “recoverySearchSpaceId” in the RRC signaling.

Optionally, the multiple search spaces may correspond to the multiple CORESETs. One search space may uniquely correspond to (or be associated with) one CORESET, and the CORESETs corresponding to (or associated with) different search spaces may be the same or different, which is not limited in the embodiments of the present disclosure.

Optionally, configuration information of each search space may indicate search space ID information corresponding to (or associated with) the search space. Exemplarily, the CORESET corresponding to each search space may be indicated by an information field “controlResourceSetId” in the RRC signaling.

Optionally, in the embodiment of the present disclosure, the at least one first TCI state is the unified TCI state, and the type of the at least one first TCI state may be the joint TCI state or the DL TCI state, which is not limited in the embodiments of the present disclosure.

In the embodiment of the present disclosure, the at least one first TCI state is used for DL operation/DL transmission/DL reception. In the subsequent description, for the sake of simplification, only a part of the DL operation/DL transmission/DL reception is often mentioned, for example, for the DL or for the DL transmission.

It is to be understood that the type of the at least one first TCI state may be configured by the network device. The network device may send seventh indication information or eighth indication information to the terminal device, and configure the type of the at least one first TCI state through the seventh indication information or the eighth indication information.

In a possible implementation, if the terminal device receives the seventh indication information sent by the network device, and the seventh indication information is used for indicating that the type of the unified TCI state is the joint TCI state, then, the at least one first TCI state in operation 310 is the joint TCI state.

Herein, the joint TCI state may be used for UL operation or UL transmission, or may be used for DL operation/DL transmission/DL reception.

Optionally, the seventh indication information is indicated by a RRC IE information field “unifiedTCI-StateType”, and has a value “joint”.

Optionally, the seventh indication information is configured for a serving cell.

Optionally, the seventh indication information may be carried in a RRC IE information field “ServingCellConfig”.

Optionally, in this implementation, the at least one first TCI state may be TCI state(s) in a first TCI state group. The first TCI state group may be used for UL operation or UL transmission, and may also be simultaneously used for DL operation/DL transmission/DL reception.

Optionally, the first TCI state group may be configured by the network device through ninth indication information.

Optionally, the ninth indication information may be configured through a RRC signaling.

Optionally, the ninth indication information may be configured through a RRC IE information field “PDSCH-Config”.

Optionally, the ninth indication information may be indicated through a RRC IE information field “dl-OrJoint-TCIStateList”.

In another possible implementation, if the terminal device receives the eighth indication information sent by the network device, and the eighth indication information is used for indicating that the type of the unified TCI state is the separate TCI state, then, the at least one first TCI state in operation 310 is the DL TCI state.

Herein, the DL TCI state is used for DL operation/DL transmission/DL reception.

Optionally, the eighth indication information is indicated through a RRC IE information field “unifiedTCI-StateType”, and has a value “Separate”.

Optionally, the eighth indication information is configured for a serving cell.

Optionally, the eighth indication information may be carried in a RRC IE information field “ServingCellConfig”.

Optionally, in this implementation, the at least one first TCI state may be TCI state(s) in a second TCI state group. The second TCI state group is used for DL operation/DL transmission/DL reception.

Optionally, the second TCI state group may be configured by the network device through tenth indication information.

Optionally, the tenth indication information may be configured through a RRC signaling.

Optionally, the tenth indication information may be configured through a RRC IE information field “PDSCH-Config”.

Optionally, the tenth indication information may be indicated through a RRC IE information field “dl-OrJoint-TCIStateList”.

Optionally, in this implementation, the network device may further send eleventh indication information to the terminal device, and the eleventh indication information is used for configuring or indicating a third TCI state group, where the third TCI state group is used for UL operation or UL transmission.

Optionally, the eleventh indication information may be configured through a RRC IE information field “BWP-UplinkDedicated”.

Optionally, the eleventh indication information may be indicated through a RRC IE information field “ul-TCI-ToAddModList”.

Optionally, the seventh indication information and the cighth indication information may be indicated through the same RRC parameter, but with different values for the corresponding RRC parameter.

In the embodiment of the present disclosure, the terminal device may determine at least one first TCI state for the first PDCCH. The at least one first TCI state may be used for DL operation/DL transmission/DL reception. It is to be understood that the at least one first TCI state for the first PDCCH refers to first TCI state(s) for transmission of the first PDCCH. The terminal device may determine the QCL information of at least one PDCCH candidate for receiving (or monitoring) the first PDCCH based on the at least one first TCI state.

Optionally, the at least one first TCI state in the embodiment of the present disclosure may be determined by the terminal device based on the indication information sent by the network device.

Optionally, the terminal device may receive second indication information sent by the network device. The second indication information is used for configuring multiple available TCI states including the at least one first TCI state described above.

It is to be noted that the multiple available TCI states configured by the second indication information may be part or all of TCI states in the TCI state group(s) configured by at least one of the ninth indication information to the eleventh indication information. For example, the multiple available TCI states configured by the second indication information may be part or all of TCI states in the first TCI state group configured by the ninth indication information; or the multiple available TCI states configured by the second indication information may be part or all of TCI states in the second TCI state group configured by the tenth indication information and in the third TCI state group configured by the eleventh indication information.

Optionally, the multiple available TCI states may further include at least one second TCI state used for UL operation or UL transmission.

Optionally, the second indication information may be carried (or transmitted) through a first MAC CE signaling. It is to be understood that use of the MAC CE signaling has a lower delay compared to the RRC signaling, and also has the better transmission reliability, which is convenient for the network to quickly instruct the terminal device to perform corresponding operations.

Hereinafter, a specific structure of the first MAC CE signaling is described in detail.

Optionally, the first MAC CE signaling includes at least one: DL BWP indication information; UL BWP indication information; at least one TCI number (or quantity) indication information, each of which is used for indicating a number of TCI states associated with the TCI number indication information; at least one TCI type indication information, for indicating types of the multiple available TCI states; or configuration information of the multiple available TCI states.

Herein, the DL BWP indication information may be a sequence number or identifier of a DL BWP (i.e., a DL BWP ID), and the DL BWP indication information may be used for indicating a BWP used by the terminal device for the DL operation/DL transmission/DL reception. The first MAC CE may be applied to the DL BWP. Optionally, the length of an information field of the DL BWP indication information may be 2 bits.

Correspondingly, the UL BWP indication information may be a sequence number or identifier of a UL BWP (i.e., a UL BWP ID), and the UL BWP indication information may be used for indicating a BWP used by the terminal device for the UL operation or UL transmission. Optionally, the length of an information field of the UL BWP indication information may be 2 bits.

In the embodiment of the present disclosure, the first MAC CE signaling may further include K pieces of TCI number indication information, where K is an integer greater than or equal to 1. Each piece of the TCI number indication information may indicate M TCI states, where M is an integer greater than 1. Optionally, K has a value of 8 or 16, or other values, which is not limited in the embodiments of the present disclosure.

It is to be understood that the M TCI states may include the UL TCI states for the UL operation/UL transmission and the DL TCI states for the DL operation/DL transmission/DL reception. Each piece of the TCI number indication information may indicate the total number of the UL TCI states and the DL TCI states. In this way, the number of bits can be reduced and the overhead of the first MAC CE signaling can be compressed.

Optionally, the length of each piece of the TCI number indication information may be 2 bits or 3 bits, and other numbers of bits, which is not limited in the embodiments of the present disclosure.

Optionally, the value of M may be any one of 1 to 4. The number of the UL TCI states is less than or equal to 2, and the number of the DL TCI states is less than or equal to 2. Setting such value of M is simple to implement, and most of the performance gain of the multi-TRP can be obtained, and moreover, the flexibility of the network configuration and scheduling can be improved.

Optionally, in a case where M is less than or equal to 4, one codepoint in an information field where each piece of the TCI number indication information is located may correspond to one or two joint TCI states.

Optionally, the value of M may be any one of 1 to 6. The number of the DL TCI states is less than or equal to 4, and the number of the UL TCI states is less than or equal to 2. Setting such value of M can support more TRPs for the DL transmission, which can improve DL performance and provide greater freedom for network optimization in a part of scenarios.

Optionally, the value of M may be any one of 1 to 8. The number of the DL TCI states is less than or equal to 4, and the number of the UL TCI states is less than or equal to 4. Setting such value of M can support more TRPs for the DL transmission and the UL transmission, which can improve the DL and UL performance and provide greater freedom for network optimization in a part of scenarios.

Optionally, in a case where M is less than or equal to 6, or M is less than or equal to 8, one codepoint in an information field where each piece of the TCI number indication information is located may correspond to 1, 2, 3, or 4 joint TCI states.

In the embodiment of the present disclosure, the first MAC CE signaling may further include the at least one TCI type indication information for indicating whether the corresponding TCI state is a DL/joint TCI state or a UL TCI state.

Optionally, the TCI type indication information is used for indicating whether the TCI state located in the same octet is the DL/joint TCI state or the UL TCI state.

Optionally, the TCI type indication information is used for indicating whether the TCI state located in the same octet belongs to the second TCI state group or the third TCI state group.

In the embodiment of the present disclosure, the first MAC CE signaling may include multiple TCI indication fields for indicating the configuration information of the multiple available TCI states. Each TCI indication field may indicate configuration information of one TCI state.

Optionally, the configuration information may include a TCI state ID, QCL information 1, and QCL information 2.

Optionally, the first MAC CE signaling may further include one or more octet indication information corresponding to the multiple TCI indication fields, and each octet indication information is used for indicating whether a TCI indication field corresponding to the octet indication information is present.

Exemplarily, with reference to the first schematic structural diagram of the first MAC CE signaling illustrated in FIG. 4, Cᵢ is the octet indication information, where i is an integer greater than or equal to 0. Cᵢ may indicate whether a TCI state (i.e., TCI state ID_{i,2} in FIG. 4) included in another octet located after the octet to which Cᵢ belongs is present.

Optionally, if the configuration information of the TCI state is used for configuring the DL/joint TCI state, the length of the configuration information of the TCI state is 7 bits.

Optionally, if the configuration information of the TCI state is used for configuring the UL TCI state, then, the most significant bit of the configuration information of the TCI state is a reserved bit, and the remainder 6 bits indicate the UL TCI state.

Optionally, if the configuration information of the TCI state is used for configuring the UL TCI state, all seven bits of the configuration information of the TCI state may be used for indicating the UL TCI state, which can indicate more UL TCI states and improve the flexibility of the network scheduling.

Optionally, the first MAC CE signaling may include serving cell indication information in addition to the above information. Exemplarily, a serving cell ID may be used for indicating a corresponding serving cell. The length of the serving cell indication information is 5 bits. The first MAC CE signaling in the embodiment of the present disclosure is applied to the indicated serving cell.

Optionally, the first MAC CE signaling may further include TCI state subset (or referred to as DCI codepoint) number indication information indicating a positive integer value between 1 and K. Optionally, the number of the TCI state subsets refers to the number of codepoints in a first information field of the DCI corresponding to the TCI states indicated in the first MAC CE signaling. Optionally, the first information field is a “Transmission configuration indication” information field in the DCI. By indicating the number of the codepoints in the DCI in the first MAC CE signaling, some bits of information read/parsed by the terminal device can be reduced, which reduces the implementation complexity.

Optionally, the maximum number of the TCI states indicated (which may also be referred to as activated) in the first MAC CE signaling may be 32, 48, or 64.

It is to be understood that if the maximum number of the TCI states indicated by the first MAC CE signaling is 32, the terminal device supports at most 2-TRP transmission for both the UL and the DL. If the maximum number of the TCI states indicated by the first MAC CE signaling is 48, the terminal device supports at most 4-TRP transmission for the DL and 2-TRP transmission for the UL, so as to improve the DL transmission performance and the flexibility of the network configuration and scheduling, and moreover, the implementation complexity of the terminal device is controlled within a certain range. If the maximum number of the TCI states indicated by the first MAC CE signaling is 64, the terminal device supports at most 4-TRP transmission for the DL and 4-TRP transmission for the UL, so as to improve UL and DL transmission performance and flexibility of the network configuration and scheduling, and the implementation complexity of the terminal device is high.

Optionally, the maximum number of the joint TCI states indicated (which may also be referred to as activated) by the first MAC CE is 16 or 32.

In an example, with reference to the first schematic structural diagram of the first MAC CE signaling illustrated in FIG. 4, the first MAC CE signaling may include: a serving cell ID, a DL BWP ID, a UL BWP ID, a TCI state ID_{i,j}, octet indication information Cᵢ, and a reserved bit R, where i has a value from 0 to M−1 and j has a value from 0 to K−1.

Herein, each TCI state ID_{i,j} may be used for indicating a TCI state in the first TCI state group, i may correspond to the sequence number of a codepoint in the information field “Transmission configuration indication” of the DCI, and the TCI state ID_{i,j} indicates the j-th TCI state corresponding to the i-th codepoint in the information field “Transmission configuration indication” of the DCI.

It is to be noted that there are various schemes for the correspondences between the TCI states and the codepoints. For example, the TCI state ID_{0,1} and the TCI state ID_{0,2} correspond to the information field “Transmission configuration indication” having a value (or indication value) of 0, the TCI state ID_{1,1} and the TCI state ID_{1,2} correspond to the information field “Transmission configuration indication” having a value (or indication value) of 1, and so on.

It is to be understood that for the TCI state ID_{i,j}, j being greater than 1 is optional, which depends on the indication of Cᵢ. Exemplarily, Cᵢ in FIG. 4 may be used for indicating whether an octet containing the TCI state ID_{i,2} is present. If the value of Cᵢ is 1, the octet containing the TCI state ID_{i,2} is present; and if the value of Cᵢ is 0, the octet containing the TCI state ID_{i,2} is not present. Alternatively, if the value of Cᵢ is 1, the octet containing the TCI state ID_{i,2} is not present; and if the value of Cᵢ is 0, the octet containing the TCI state ID_{i,2} is present.

In addition, R is a reserved bit, and may have a value of 0 or other specific value, which is not limited in the embodiments of the present disclosure.

It is to be noted that the above-described structure of the first MAC CE signaling is merely an illustration, the positions of different information fields may be adjusted, and some information in the above-described first MAC CE signaling may be optional, i.e., part of the above-described information may not be included in the first MAC CE signaling.

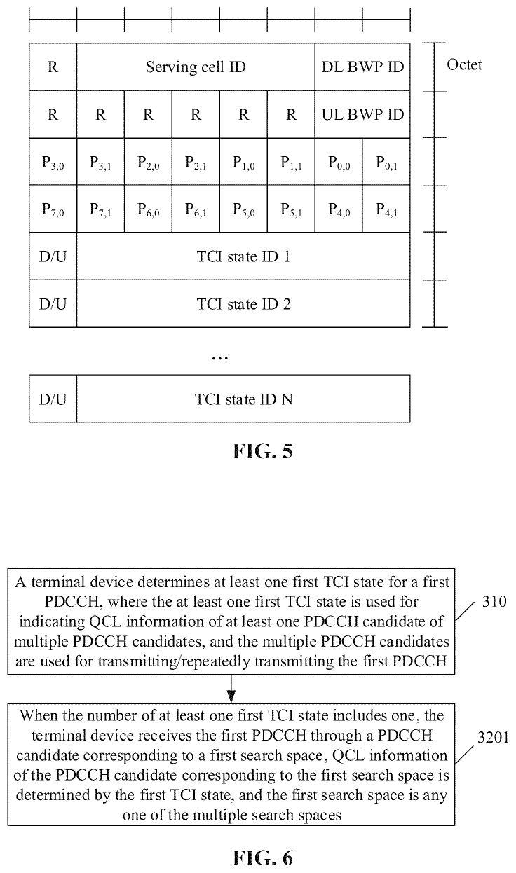

In another example, with reference to the second schematic structural diagram of a first MAC CE illustrated in FIG. 5, the first MAC CE signaling may include: a serving cell ID, a DL BWP ID, a UL BWP ID, a TCI state ID, multiple pieces of TCI number indication information, TCI type indication information (represented by D/U in FIG. 5), and a reserved bit R.

Herein, each piece of the TCI number indication information may be indicated by a subset of bits composed of P_{i,0} and P_{i,1}. A value of the subset of bits composed of the P_{i,0} and P_{i,1} indicates that the i-th codepoint in the information field “Transmission configuration indication” of the DCI corresponds to M TCI states.

Optionally, the value of M may be any one of 1 to 4. For example, the values of 00, 01, 10, and 11 of the P_{i,0} and P_{i,1} respectively correspond to the values of 1, 2, 3, and 4 of M. The values of 00, 10, 01 and 11 of the P_{i,0} and P_{i,1} respectively correspond to the values of 1, 2, 3, and 4 of M. There are no more than 2 DL TCI states among the M TCI states, and there are no more than 2 UL TCI states among the M TCI states. Optionally, P_{i,0} and P_{i,1} may indicate 1 or 2 joint TCI states corresponding to the i-th codepoint.

It is to be understood that each piece of the TCI number indication information may indicate the total number of UL TCI states and DL TCI states. In this way, the number of bits can be reduced and the overhead of the first MAC CE signaling can be compressed.

Optionally, the value of i may start from 0 (as the example in FIG. 5) or start from 1, which is not limited in the embodiment of the present disclosure.

Optionally, in a case where the network device indicates that the type of the unified TCI state is the joint TCI state through the seventh indication information, P_{i,0} and P_{i,1} may indicate that the i-th codepoint corresponds to M1 DL TCI states and M2 UL TCI states, respectively. For example, P_{i,0} indicates the M1 DL TCI states, and P_{i,1} indicates the M2 UL TCI states; or P_{i,0} indicates the M2 UL TCI states and Pi indicates the M1 DL TCI states. The indication manner is not limited in the embodiments of the present disclosure.

Optionally, the values of M1 and M2 may be any one of 1 and 2.

It is to be understood that by indicating the number of the DL TCI states and the number of the UL TCI states separately, the MAC CE signaling can be designed more flexibly to facilitate the expansion of the scheme in the future.

In addition, in the embodiment of the present disclosure, the TCI type indication information (represented by D/U in FIG. 5) is used for indicating whether the TCI state indicated by the TCI state ID in the same octet is the DL/joint TCI state or the UL TCI state.

Exemplarily, the D/U having a value of 1 indicates that the type of the TCI state indicated by the TCI state ID in the same octet is the DL/joint TCI state; the D/U having a value of 0 indicates that the type of the TCI state indicated by the TCI state ID in the same octet is the UL TCI state. Alternatively, the D/U having the value of 0 indicates that the type of the TCI state indicated by the TCI state ID in the same octet is the DL/joint TCI state; and the D/U having the value of 1 indicates that the type of the TCI state indicated by the TCI state ID in the same octet is the UL TCI state. The specific indication manner is not limited in the embodiments of the present disclosure.

Optionally, the TCI state ID indicates a TCI state that may be the DL TCI state/joint TCI state, or may be the UL TCI state. Exemplarily, if the value of D/U is 1, the type of the TCI state indicated by the TCI state ID is the DL/joint TCI state, and the length of a TCI state ID information field is 7 bits. If the value of the D/U field is 0, the type of the TCI state indicated by the TCI state ID is the UL TCI state, and the length of the TCI state ID information field is 7 bits or 6 bits. When the length of the TCI state ID information field is 7 bits, the most significant bit of the TCI state ID is a reserved bit, and the remainder 6 bits indicate the UL TCI state.

In some embodiments, the terminal device may determine multiple available (activated) TCI states indicated by the network device based on the above information carried in the first MAC CE signaling. Specifically, the at least one first TCI state for the first PDCCH transmission may be TCI state(s) for DL operation/transmission/reception among the multiple available (activated) TCI states configured in the first MAC CE signaling.

In another embodiment, the terminal device may further receive first indication information sent by the network device, and the first indication information is used for indicating at least one TCI state among the multiple available TCI states. Specifically, the at least one first TCI state for the first PDCCH transmission may be TCI state(s) used for DL operation/transmission/reception among the at least one TCI state indicated in the first indication information.

Optionally, the first indication information may indicate at least one of: QCL information corresponding to PDSCH Demodulation Reference Signal(s) (DMRSs); QCL information corresponding to PDCCH DMRS(s) or QCL information corresponding to DMRS(s) corresponding to a part of CORESETs; QCL information corresponding to at least part of CSI-RSs; UL TX spatial filter(s) for PUSCH(s); UL TX spatial filter(s) for at least part of PUCCHs; or UL TX spatial filter(s) for at least part of SRSs.

Optionally, the first indication information may be the same as the second indication information. That is to say, the terminal device may determine the at least one first TCI state for the first PDCCH transmission based on only the first MAC CE signaling. For example, if the first MAC CE only indicates the TCI state(s) corresponding to the first codepoint and does not indicate the TCI states corresponding to other codepoints, and the first codepoint corresponds to the TCI states X1 and X2, then, the terminal device may directly determine the at least one first TCI state based on the TCI states X1 and X2.

Alternatively, the first indication information may be different from the second indication information. That is to say, the terminal device may determine multiple available (or referred to as active) TCI states based on the first MAC CE signaling. The network device indicates at least one TCI state among the available TCI states through the second indication information, to inform the terminal device of the at least one TCI state applied by the network device. Furthermore, the terminal device may determine the at least one first TCI state for the first PDCCH transmission based on the first indication information and the second indication information.

Optionally, the first indication information may be transmitted through a RRC signaling or a MAC CE signaling (e.g., the first MAC CE signaling).

Alternatively, the first indication information may be transmitted by a DCI. Optionally, the first indication information may be transmitted through the information field “Transmission configuration indication” in the DCI. For example, if the first MAC CE indicates that the first codepoint corresponds to the TCI states X1 and X2, the second codepoint corresponds to the TCI state X3, and the first indication information indicates the first codepoint through the corresponding information field in the DCI, the terminal device may determine the at least one first TCI state based on the TCI states X1 and X2.

Optionally, the DCI may have DCI format 1_1 and/or DCI format 1_2. The DCI format 1_1/DCI format 1_2 may schedule data or not schedule DL transmission.

Optionally, the DCI is at least one of DCI format 1_1, DCI format 1_2, DCI format 0_1, and DCI format 0_2. The DCI format 1_1/DCI format 1_2 may schedule data or not schedule DL transmission (i.e., with or without DL assignment), and the DCI format 0_1/DCI format 0_2 may schedule data or not schedule UL transmission (i.e., with or without UL assignment).

Optionally, if not schedule DL transmission (i.e., without DL assignment), the terminal device may have the following assumptions for the DCI format 1_1/DCI format 1_2 (In other words, the DCI format 1_1/DCI format 1_2 satisfies the following conditions): a Reference Signal-Radio Network Temporary Identifier (CS-RNTI) is used to scramble the CRC for the DCI; or the settings of the DCI information fields include: RV=all ‘1’s, MCS=all ‘1’s, and NDI=0; in addition, they are set to all ‘0’s for FDRA Type 0, or set to all ‘1’s for FDRA Type 1; or set to all ‘0’s for dynamicSwitch.

Optionally, if the at least one TCI state (e.g., the TCI state X) of the one or more TCI states indicated by the first indication information is different from any one of the previously indicated TCI states, or if the at least one TCI state (e.g. the TCI state X) of the one or more TCI states indicated by the second indication information is different from any one of all the TCI states currently activated/applied by the first terminal device, then, the TCI state X indicated by the first indication information is applied starting from the first time-domain unit (e.g., slot) that is at least BeamAppTime symbols after the last symbol of the first PUCCH. That is to say, the terminal device may determine the UL TX spatial filter and/or QCL information corresponding to the DL transmission/reception based on the TCI state X. The first PUCCH transmits HARQ-ACK information corresponding to the DCI for carrying the first indication information.

Exemplarily, let's consider an example where a DCI can indicate at most two TCI states for DL operation/transmission/reception. It is assumed that the network device previously indicated TCI state A1 and TCI state A2 for the DL transmission, and the signal indicated by the current DCI contains the TCI state X, and the TCI state X is different from the TCI state A1/TCI state A2, then the above procedure is required to be considered to determine when the TCI state X can be applied. For another example, at present, the terminal device determines the QCL information corresponding to DL transmission by using one or two TCI states (denoted as TCI state A1, and TCI state A2), the signal indicated by the current DCI contains the TCI state X, and TCI state X is different from the TCI state A1/TCI state A2, then the above procedure is required to be considered to determine when the TCI state X can be applied.

Optionally, when the current TCI state indicated by the first indication information is compared with the previously indicated TCI state, a priority is given to the TCI states in the same direction. For example, if the TCI state X is used for the UL transmission, it is considered that the previously indicated TCI state for the UL transmission is different from the TCI state X. If the TCI state X is used for the DL transmission/reception, it is considered that the previously indicated TCI state for the DL transmission/reception is different from the TCI state X. If the TCI state X is used for the UL transmission and the DL transmission/reception, it is considered that the previously indicated TCI state for the UL transmission and the DL transmission/reception is different from the TCI state X.

It is to be noted that, in the system, there are usually multiple indications of the first indication information. The “previously indicated” referred to in the above scheme may be understood as being indicated by the previous first indication information, for example, by the most recent first indication information.

Optionally, the BeamAppTime is determined based on capability reporting by the terminal device, or the BeamAppTime is determined by the configuration of the network, which is not limited in the embodiments of the present disclosure.

It is to be noted that, for the PDCCH repetition or when the terminal device receives or monitors PDCCH candidates in multiple search spaces, similar requirement for timing also needs to be considered for the case that different TCI states are used for the reception or monitoring.

It is to be noted that the above-described structure of the first MAC CE signaling is merely an illustration, the positions of different information fields may be adjusted, and some information in the above-described first MAC CE signaling may be optional, i.e., part of the above-described information may not be included in the first MAC CE signaling.

In the embodiment of the present disclosure, the second indication information sent by the network device may indicate multiple available (active) TCI states, and the first indication information may indicate applied N TCI states among the multiple available (active) TCI states. Accordingly, the terminal device may determine N TCI states based on the first indication information and the second indication information.

Optionally, at least part of the N TCI states are used for determining/indicating the QCL information corresponding to the DL operation/transmission/reception.

Optionally, the N TCI states may include first TCI state(s) for DL operation/transmission/reception, and/or second TCI state(s) for UL transmission/sending. The number of the first TCI states may be K1, and the number of the second TCI states may be K2, where 0<=K1<=N, 0<=K2<=N. For example, N=K1=K2, N=K1, K2=0, or other combinations, which are not limited in the embodiments of the present disclosure.

Optionally, in some embodiments, the K1 first TCI states may be used for indicating the QCL information (or QCL hypothesis) of PDCCH candidate(s) corresponding to at least one search space among the multiple search spaces. Accordingly, the terminal device may determine, based on the KI first TCI states, the QCL information (or QCL hypothesis) of PDCCH candidates respectively corresponding to the multiple search spaces for first PDCCH transmission, or the terminal device may determine, based on the K1 first TCI states, the QCL information (or QCL hypothesis) of PDCCH DMRS candidates respectively corresponding to the multiple search spaces.

It is to be understood that determining the QCL information for a certain search space may increase more flexibility. For example, the same CORESET corresponds to multiple search spaces, and the PDCCH candidates corresponding to at least part of the multiple search spaces may use different QCL information.

Exemplarily, the K1 first TCI states include a first TCI state 1 and a first TCI state 2, the first search space is linked with the second search space, and the first search space and the second search space are used for the first PDCCH repetition. Specifically, the QCL information of the PDCCH candidate/PDCCH DMRS candidate corresponding to the first search space may be determined based on the first TCI state 1, and/or the QCL information of the PDCCH candidate/PDCCH DMRS candidate corresponding to the second search space may be determined based on the first TCI state 2.

Optionally, in other embodiments, the K1 first TCI states are used for indicating the QCL information of PDCCH candidate(s) corresponding to at least one CORESET among the multiple CORESETs. Accordingly, the terminal device determines, based on the K1 first TCI states, the QCL information (or the QCL hypothesis) of PDCCH candidates corresponding to the multiple CORESETs, or the terminal device determines, based on the K1 first TCI states, the QCL information (or the QCL hypothesis) of PDCCH DMRS candidates corresponding to the multiple CORESETs.

It is to be understood that the same CORESET corresponds to multiple search spaces, and PDCCHs corresponding to the multiple search spaces may use the same QCL information. Determining the QCL information for a certain CORESET maintains principles similar to the existing mechanism, which can reduce implementation complexity.

Exemplarily, the K1 first TCI states include a first TCI state 1 and a first TCI state 2, the first search space and the second search space are used for the first PDCCH repetition, and the first search space corresponds to the first CORESET and the second search space corresponds to the second CORESET. Specifically, the QCL information of the PDCCH candidate/PDCCH DMRS candidate corresponding to the first CORESET is determined based on the first TCI state 1, and/or the QCL information of the PDCCH candidate/PDCCH DMRS candidate corresponding to the second CORESET is determined based on the first TCI state 2.

Hereinafter, a transmission method of the first PDCCH is described in detail.

In some embodiments, with reference to FIG. 6, in a case where the number of the at least one first TCI state includes one (i.e., K1=1), the operation that the terminal device receives the first PDCCH based on the at least one first TCI state in operation 320 may be implemented in a following manner.

In operation 3201, the terminal device receives the first PDCCH through a PDCCH candidate corresponding to a first search space, QCL information of the PDCCH candidate corresponding to the first search space is determined by the first TCI state, and the first search space is any one of the multiple search spaces.

It is to be noted that in a case where a single first TCI state is configured, the terminal device may receive only one PDCCH candidate and determine the QCL information of the PDCCH candidate/PDCCH DMRS candidate based on the single first TCI state. In this way, the processing complexity of the terminal device is reduced, and the energy consumption of the terminal device is saved.

Optionally, the first search space is determined according to any one of the following: the first search space is a search space with a search space ID being a first specified ID among the multiple search spaces; the first search space is a search space corresponding to a CORESET with a CORESET ID being a second specified ID among the multiple CORESETs, where the multiple CORESETs correspond to the multiple search spaces; or the first search space is determined based on third indication information sent by the network device.

It is to be understood that the first search space may be determined according to predefined rules or may be configured by the network.

Optionally, the first specified ID is the smallest search space ID among search space IDs of the multiple search spaces, or the largest search space ID among the search space IDs of the multiple search spaces. Alternatively, the first specified ID may be the second smallest search space ID or the second largest search space ID among search space IDs of the multiple search spaces, which is not limited in the embodiments of the present disclosure.

Optionally, the second specified ID is the smallest CORESET ID among CORESET IDs of the multiple CORESETs, or the largest CORESET ID among the CORESET IDs of the multiple CORESETs. Alternatively, the second specified ID may be the second smallest CORESET ID or the second largest CORESET ID among CORESET IDs of the multiple CORESETs, which is not limited in the embodiments of the present disclosure.

That is to say, the first search space may be a search space with the smallest (or largest) search space ID among the multiple search spaces, or the first search space may be a search space corresponding to a CORESET with the smallest (or largest) CORESET ID among the multiple CORESETs.

In the embodiment of the present disclosure, the first search space may be determined based on the search space ID, or the first search space may be determined based on the CORESET ID, which is not limited in the embodiments of the present disclosure.

It is to be understood that by determining the first search space through the predefined rule, the implementation complexities of the terminal device and the network device can be effectively reduced.

In the embodiment of the present disclosure, the first search space may be configured by the network device through the third indication information.

Optionally, the third indication information may be carried through a RRC signaling or a MAC CE signaling. The carrying through the RRC signaling can improve transmission reliability, and the carrying through the MAC CE signaling can improve flexibility. It is to be noted that the third indication information may be the same as the first indication information and/or the second indication information; or the third indication information may be different from the first indication information and the second indication information, which is not limited in the embodiments of the present disclosure.

Optionally, if the third indication information is transmitted through the RRC signaling, the third indication information may be configured for a terminal device, or for a serving cell, or for a serving cell group, or for a BWP, or for a CORESET, or for a search space, or for a group of search spaces linked with each other (the group of search spaces herein may include the multiple search spaces for the PDCCH repetition described above), which is not limited in the embodiments of the present disclosure.

Optionally, if the third indication information is transmitted through the MAC CE signaling, the third indication information may be configured for a list of serving cells (that may be configured by the network device), for a serving cell, for a BWP, for a CORESET, for a search space, or for a group of search spaces linked with each other, which is not limited in the embodiments of the present disclosure. It is to be noted that the configured objects may be different due to the signalings for transmitting the third indication information are different.

Optionally, the third indication information is used for indicating any one of the following: a search space ID of the first search space; a CORESET ID of a CORESET corresponding to the first search space; the first search space is the search space with the search space ID being the first specified ID among the multiple search spaces; or the first search space is the search space corresponding to the CORESET with the CORESET ID being the second specified ID among the multiple CORESETs.

It is to be understood that the network device may directly indicate the first search space through the search space ID of the first search space. The network device may also indicate the first search space through the CORESET ID corresponding to the first search space. If the CORESET ID indicated by the third indication information corresponds to multiple search spaces, the search space with the smallest/largest search space ID among the multiple search spaces is taken as the first search space.

The network device may further indicate, through the third indication information, that the first search space is a specified search space among the multiple search spaces, or a search space corresponding to a specified CORESET among the CORESETs. The third indication information may include multiple indication values, and different indication values may indicate different search spaces. In addition, the network device may indicate different search spaces by configuring the third indication information or not configuring the third indication information. The configuration manner of the specified search space is not limited in the embodiments of the present disclosure.

Exemplarily, the search space for repeatedly transmitting the first PDCCH includes a search space 1 and a search space 2. The search space 1 corresponds to the CORESET1 and the search space 2 corresponds to the CORESET2. In the case where the network device configures a single first TCI state, the first search space may be determined by the following manner A1 to manner A5.

In the manner A1, the first search space is a search space with the smallest search space ID among the search space 1 and the search space 2. If the ID of the search space 1 (hereinafter, SS-ID1 is used for representing the ID of the search space 1 for the sake of brevity) is smaller than the ID of the search space 2 (hereinafter, SS-ID2 is used for representing the ID of the search space 2 for the sake of brevity), then the first search space is the search space 1; and if SS-ID2<SS-ID1, the first search space is the search space 2.

In the manner A2, the first search space is a search space with the largest search space ID among the search space 1 and the search space 2. If SS-ID1>SS-ID2, then the first search space is the search space 1; and if SS-ID2>SS-ID1, then the first search space is the search space 2.

In the manner A3, the first search space is a search space corresponding to a CORESET with the smallest CORESET ID among CORESET1 and CORESET2. If the ID of the CORESET1 (hereinafter, C-ID1 is used for representing the ID of CORESET1 for the sake of brevity) is smaller than the ID of the CORESET2 (hereinafter, C-ID2 is used for representing the ID of the CORESET2 for the sake of brevity), then the first search space is the search space 1 corresponding to the CORESET1; and if C-ID2<C-ID1, then the first search space is the search space 2 corresponding to the CORESET2.

In the manner A4, the first search space is a search space corresponding to a CORESET with the largest CORESET ID among the CORESET1 and the second CORESET2. If C-ID1>C-ID2, then the first search space is the search space 1 corresponding to the CORESET1; and if C-ID2>C-ID1, then the first search space is the search space 2 corresponding to the CORESET2.

In the manner A5, the first search space is determined based on the third indication information sent by the network device.

Optionally, when the value of the third indication information is a1 (such as, 0 or 1), the terminal device determines the first search space according to the manner A1; and when the value of the third indication information is a2 (such as, 1 or 0), the terminal device determines the first search space according to the manner A2.

Optionally, when the network device configures or indicates the third indication information, the terminal device determines the first search space according to the manner A1; and when the network device does not configure or indicate the third indication information, the terminal device determines the first search space according to the manner A2. Alternatively, conversely, when the network device configures or indicates the third indication information, the terminal device determines the first search space according to the manner A2; and when the network device does not configure or indicate the third indication information, the terminal device determines the first search space according to the manner A1. Compared with the method that the third indication information directly indicates a1 and a2, the signaling overhead can be reduced by configuring or not configuring the third indication information to indicate different first search spaces.

Optionally, when the value of the third indication information is a3 (such as, 0 or 1), the terminal device determines the first search space according to the manner A3; and when the value of the third indication information is a4 (such as, 1 or 0), the terminal device determines the first search space according to the manner A4.

Optionally, when the network device configures or indicates the third indication information, the terminal device determines the first search space according to the manner A3; and when the network device does not configure or indicate the third indication information, the terminal device determines the first search space according to the manner A4. Alternatively, conversely, when the network device configures or indicates the third indication information, the terminal device determines the first search space according to the manner A4; and when the network device does not configure or indicate the third indication information, the terminal device determines the first search space according to the manner A3. Compared with the method that the third indication information directly indicates a3 and a4, the signaling overhead can be reduced by configuring or not configuring the third indication information to indicate different first search spaces.

Optionally, when the value of the third indication information is a5 (such as, 0 or 1), the terminal device determines the first search space according to the manner A1; and when the value of the third indication information is a6 (such as, 1 or 0), the terminal device determines the first search space according to the manner A3.

Optionally, when the network device configures or indicates the third indication information, the terminal device determines the first search space according to the manner A1; and when the network device does not configure or indicate the third indication information, the terminal device determines the first search space according to the manner A3. Alternatively, conversely, when the network device configures or indicates the third indication information, the terminal device determines the first search space according to the manner A3; and when the network device does not configure or indicate the third indication information, the terminal device determines the first search space according to the manner A1. Compared with the method that the third indication information directly indicates a5 and a6, the signaling overhead can be reduced by configuring or not configuring the third indication information to indicate different first search spaces.

Optionally, when the value of the third indication information is a7 (such as, 0 or 1), the terminal device determines the first search space according to the manner A2; and when the value of the third indication information is a8 (such as, 1 or 0), the terminal device determines the first search space according to the manner A4.

Optionally, when the network device configures or indicates the third indication information, the terminal device determines the first search space according to the manner A2; and when the network device does not configure or indicate the third indication information, the terminal device determines the first search space according to the manner A4. Alternatively, conversely, when the network device configures or indicates the third indication information, the terminal device determines the first search space according to the manner A4; and when the network device does not configure or indicate the third indication information, the terminal device determines the first search space according to the manner A2. Compared with the method that the third indication information directly indicates a7 and a8, the signaling overhead can be reduced by configuring or not configuring the third indication information to indicate different first search spaces.

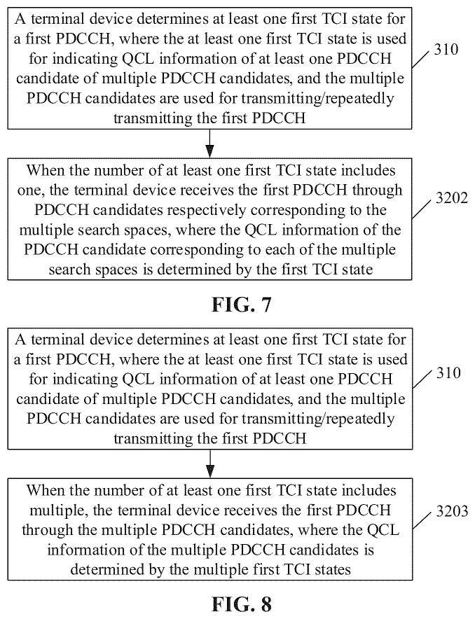

In some embodiments, with reference to FIG. 7, in the case where the number of the at least one first TCI state includes one, the operation that the terminal device receives the first PDCCH based on the at least one first TCI state in operation 320 may be implemented in a following manner.

In operation 3202, the terminal device receives the first PDCCH through PDCCH candidates respectively corresponding to the multiple search spaces, where QCL information of a PDCCH candidate corresponding to each of the multiple search spaces is determined by the first TCI state.

It is to be understood that even if the network device indicates only a single first TCI state, the PDCCH repetition is still supported. That is to say, the terminal device may receive/monitor, in each of multiple search spaces, the PDCCH candidate corresponding to the search space. Moreover, the terminal device determines the QCL information of the PDCCH candidates/PDCCH DMRS candidates in the multiple search spaces based on the single first TCI state. In this way, the reliability of PDCCH transmission is improved.

Optionally, whether the terminal device receives/monitors the first PDCCH in the manner of operation 3201 or in the manner of operation 3202 may be predefined or configured by the network device.

In some embodiments, the number of at least one first TCI state includes one, and the method in the embodiment of the present disclosure may further include following operation.

The terminal device receives fourth indication information sent by the network device, where the fourth indication information is used for indicating the terminal device to receive the first PDCCH through a PDCCH candidate corresponding to a first search space, or the fourth indication information is used for indicating the terminal device to receive the first PDCCH through PDCCH candidates respectively corresponding to the multiple search spaces, where the first search space is any one of the multiple search spaces.

It is to be understood that compared with the method of determining whether or not to adopt a PDCCH repetition based on predefined rules in the above operation 3201 and operation 3202, determining whether or not to adopt the PDCCH repetition based on the fourth indication information can improve the flexibility of the system and provide greater freedom for network optimization configuration and transmission.

Optionally, the fourth indication information is carried through a RRC signaling or a MAC CE signaling. The carrying through the RRC signaling can improve the transmission reliability, and the carrying through the MAC CE signaling can improve the flexibility. It is to be noted that the fourth indication information may be the same as at least one of the first indication information, the second indication information, or the third indication information; or the fourth indication information may be different from the first indication information, the second indication information, and the third indication information, which is not limited in the embodiments of the present disclosure.

Optionally, if the fourth indication information is transmitted through the RRC signaling, the fourth indication information may be configured for a terminal device, or for a serving cell, or for a serving cell group, or for a BWP, or for a CORESET, or for a search space, or for a group of search spaces linked with each other (the group of search spaces herein may include the multiple search spaces for the PDCCH repetition described above), which is not limited in the embodiments of the present disclosure.

Optionally, if the fourth indication information is transmitted through the MAC CE signaling, the fourth indication information may be configured for a list of serving cells (that may be configured by the network device), for a serving cell, for a BWP, for a CORESET, for a search space, or for a group of search spaces linked with each other. It is to be noted that the configured objects may be different due to the signalings for transmitting the fourth indication information are different.

Optionally, when a value of the fourth indication information is a first value, the terminal device receives the first PDCCH through the PDCCH candidate corresponding to the first search space; and when the value of the fourth indication information is a second value, the terminal device receives the first PDCCH through the PDCCH candidates respectively corresponding to the multiple search spaces.

Optionally, when the fourth indication information is configured by the network device, the terminal device receives the first PDCCH through the PDCCH candidate corresponding to the first search space; and when the fourth indication information is not configured by the network device, the terminal device receives the first PDCCH through the PDCCH candidates respectively corresponding to the multiple search spaces.

Alternatively, when the fourth indication information is not configured by the network device, the terminal device receives the first PDCCH through the PDCCH candidate corresponding to the first search space; and when the fourth indication information is configured by the network device, the terminal device receives the first PDCCH through the PDCCH candidates respectively corresponding to the multiple search spaces.

It is to be noted that the determination manner of the first search space is the same as the determination manner in the above-described embodiments, which will not be repeated here for the sake of simplicity.

In some embodiments, with reference to FIG. 8, in a case where the number of the at least one first TCI state includes multiple (i.e., K1>1), the operation that the terminal device receives the first PDCCH based on the at least one first TCI state in operation 320 may be implemented in a following manner.

In operation 3203, the terminal device receives the first PDCCH through the multiple PDCCH candidates, where QCL information of the multiple PDCCH candidates is determined through the multiple first TCI states.

It is to be understood that in the case where the multiple first TCI states are configured, the terminal device may receive/monitor PDCCH candidates in multiple search spaces, and the terminal device may determine the QCL information of the multiple PDCCH candidates/PDCCH DMRS candidates based on the multiple first TCI states configured by the network.

In the embodiment of the present disclosure, the terminal device may determine, based on correspondences between the multiple PDCCH candidates and the multiple first TCI states, the QCL information of each PDCCH candidate/PDCCH DMRS candidate.

Optionally, the correspondences between the multiple PDCCH candidates and the multiple first TCI states configured by the network device may be determined based on any one of the following: the terminal device determines a first TCI state corresponding to a PDCCH candidate in each of multiple search spaces based on a size order of search space IDs of the multiple search spaces and a size order of IDs of the multiple first TCI states; the terminal device determines a first TCI state corresponding to a PDCCH candidate in each of multiple search spaces based on a size order of search space IDs of the multiple search spaces and positions of the multiple first TCI states in the second indication information; the terminal device determines a first TCI state corresponding to a PDCCH candidate in each of multiple CORESETs based on a size order of CORESET IDs of the multiple CORESETs and a size order of IDs of the multiple first TCI states; the terminal device determines a first TCI state corresponding to a PDCCH candidate in each of multiple CORESETs based on a size order of CORESET IDs of the multiple CORESETs and positions of the multiple first TCI states in the second indication information; the terminal device determines the correspondences between the multiple PDCCH candidates and the multiple first TCI states based on fifth indication information sent by the network device; or the terminal device determines the first TCI states corresponding to the multiple PDCCH candidates based on multiple pieces of sixth indication information sent by the network device, respectively, with the multiple pieces of sixth indication information being associated with the multiple PDCCH candidates.

It is to be understood that the terminal device may determine, based on a predefined rule, the correspondences between the respective PDCCH candidates and the multiple first TCI states configured by the network.

Optionally, the terminal device may determine a first TCI state corresponding to a PDCCH candidate in each of multiple search spaces based on a size order of search space IDs of the multiple search spaces and a size order of IDs of the multiple first TCI states. Exemplarily, the search space with the smallest search space ID corresponds to the first TCI state with the smallest ID, the search space with the second smallest search space ID corresponds to the first TCI state with the second smallest ID, and so on, and the search space with the largest search space ID corresponds to the first TCI state with the largest ID. Alternatively, the search space with the largest search space ID corresponds to the first TCI state with the smallest ID, the search space with the second largest search space ID corresponds to the first TCI state with the second smallest ID, and so on, and the search space with the smallest search space ID corresponds to the first TCI state with the largest ID.

Optionally, the terminal device may determine a first TCI state corresponding to a PDCCH candidate in each of multiple search spaces based on a size order of search space IDs of the multiple search spaces and positions of the multiple first TCI states in the second indication information. It is to be understood that the second indication information may be transmitted through the first MAC CE signaling, with reference to the schematic structural diagrams of the first MAC CE illustrated in FIG. 4 or FIG. 5, different TCI states have different positions in the first MAC CE signaling. The terminal device may determine a search space corresponding to the first TCI state based on the position of the first TCI state configured by the network device in the second indication information and the first MAC CE signaling.

Exemplarily, the search space with the smallest search space ID corresponds to a first TCI state at the frontmost position in the second indication information; the search space with the second smallest search space ID corresponds to a first TCI state at the second frontmost position in the second indication information, and so on; and the search space with the largest search space ID corresponds to a first TCI state at the rearmost position in the second indication information. Alternatively, the search space with the largest search space ID corresponds to a first TCI state at the frontmost position in the second indication information; the search space with the second largest search space ID corresponds to a first TCI state at the second frontmost position in the second indication information, and so on; and the search space with the smallest search space ID corresponds to a first TCI state at the rearmost position in the second indication information.

Optionally, the terminal device may determine a first TCI state corresponding to a PDCCH candidate in each of multiple CORESETs based on a size order of CORESET IDs of the multiple CORESETs and a size order of IDs of the multiple first TCI states. Exemplarily, a search space corresponding to a CORESET with the smallest CORESET ID corresponds to a first TCI state with the smallest ID; a search space corresponding to a CORESET with the second smallest CORESET ID corresponds to a first TCI state with the second smallest ID, and so on; and a search space corresponding to a CORESET with the largest CORESET ID corresponds to a first TCI state with the largest ID. Alternatively, a search space corresponding to a CORESET with the largest CORESET ID corresponds to a first TCI state with the smallest ID; a search space corresponding to a CORESET with the second largest CORESET ID corresponds to a first TCI state with the second smallest ID, and so on; and a search space corresponding to a CORESET with the smallest CORESET ID corresponds to a first TCI state with the largest ID.

Optionally, the terminal device determines a first TCI state corresponding to a PDCCH candidate in each of multiple CORESETs based on a size order of CORESET IDs of the multiple CORESETs and positions of the multiple first TCI states in the second indication information. Exemplarily, a search space corresponding to a CORESET with the smallest CORESET ID corresponds to a first TCI state at the frontmost position in the second indication information; a search space corresponding to a CORESET with the second smallest CORESET ID corresponds to a first TCI state at the second frontmost position in the second indication information, and so on; and a search space corresponding to a CORESET with the largest CORESET ID corresponds to a first TCI state at the rearmost position in the second indication information. Alternatively, a search space corresponding to a CORESET with the largest CORESET ID corresponds to a first TCI state at the frontmost position in the second indication information; a search space corresponding to a CORESET with the second largest CORESET ID corresponds to a first TCI state at the second frontmost position in the second indication information, and so on; and a search space corresponding to a CORESET with the smallest CORESET ID corresponds to a first TCI state at the rearmost position in the second indication information.

It is to be understood that the above-described determination of the correspondences between the multiple PDCCH candidates and the multiple first TCI states based on the predefined rules can effectively reduce the implementation complexity of the terminal device and the network device, and the signaling overhead between the terminal device and the network device.

Optionally, the terminal device may further determine the correspondences between the multiple PDCCH candidates and the multiple first TCI states based on fifth indication information sent by the network device.

Optionally, the fifth indication information may be used for indicating any one of the following: the terminal device determines a first TCI state corresponding to a PDCCH candidate in each of multiple search spaces based on a size order of search space IDs of the multiple search spaces and a size order of IDs of the multiple first TCI states; the terminal device determines a first TCI state corresponding to a PDCCH candidate in each of multiple search spaces based on a size order of search space IDs of the multiple search spaces and positions of the multiple first TCI states in the second indication information; the terminal device determines a first TCI state corresponding to a PDCCH candidate in each of multiple CORESETs based on a size order of CORESET IDs of the multiple CORESETs and a size order of IDs of the multiple first TCI states; or the terminal device determines a first TCI state corresponding to a PDCCH candidate in each of multiple CORESETs based on a size order of CORESET IDs of the multiple CORESETs and positions of the multiple first TCI states in the second indication information.

Optionally, the fifth indication information may include multiple indication values, and different indication values may indicate different correspondences between the PDCCH candidates and the first TCI states. In addition, the network device may indicate different correspondences between the PDCCH candidates and the first TCI states by configuring the fifth indication information or not configuring the fifth indication information.

It is to be noted that the manner that the terminal device determines the correspondences between the PDCCH candidates and the first TCI states based on the fifth indication information may be the same as the manner as described in the above-described embodiments, which will not be repeated here for the sake of simplicity.

Optionally, the fifth indication information may be carried through a RRC signaling or a MAC CE signaling. It is to be noted that the fifth indication information may be the same as at least one of the first indication information to the fourth indication information; or the fifth indication information may be different from the first indication information to the fourth indication information, which is not limited in the embodiments of the present disclosure.

Optionally, if the fifth indication information is transmitted through the RRC signaling, the fifth indication information may be configured for a terminal device, or for a serving cell, or for a serving cell group, or for a BWP, or for a CORESET, or for a search space, or for a group of search spaces linked with each other (the group of search spaces herein may include the multiple search spaces for the PDCCH repetition described above), which is not limited in the embodiments of the present disclosure.

Optionally, if the fifth indication information is transmitted through the MAC CE signaling, the fifth indication information may be configured for a list of serving cells (that may be configured by the network device), for a serving cell, for a BWP, for a CORESET, for a search space, or for a group of search spaces linked with each other. It is to be noted that the configured objects may be different due to the signalings for transmitting the fourth indication information are different.

It is to be understood that the network device indicates the correspondences between the multiple PDCCH candidates and the multiple first TCI states through the single piece of fifth indication information, which can improve the flexibility of the system and provide greater freedom for network optimization configuration and transmission.

In addition, optionally, the terminal device may further receive multiple pieces of sixth indication information sent by the network device, where the multiple pieces of sixth indication information are associated with the multiple PDCCH candidates; and the terminal device may determine, based on respective sixth indication information associated with each PDCCH candidate, a first TCI state corresponding to the PDCCH candidate.

Optionally, each piece of sixth indication information is carried through the configuration information of the search space for the PDCCH associated with the sixth indication information, or through the configuration information of the CORESET corresponding to the search space for the PDCCH associated with the sixth indication information.

It is to be understood that the multiple pieces of sixth indication information may be associated with multiple search spaces, and thus associated with PDCCH candidates in the multiple search spaces. The multiple pieces of sixth indication information may be associated with multiple CORESETs, and thus associated with PDCCH candidates in the multiple CORESETs. That is to say, the network device may configure a piece of separate indication information for each CORESET or each search space, to indicate the first TCI state corresponding to the PDCCH candidate/PDCCH DMRS candidate in the CORESET or the search space. In this way, the network device may more flexibly control the unified TCI state corresponding to each CORESET or each search space.

Optionally, each of the multiple pieces of sixth indication information is used for indicating any one of: an ID of a first TCI state corresponding to a PDCCH candidate associated with the sixth indication information; a first TCI state corresponding to a PDCCH candidate associated with the sixth indication information is a first TCI state with an ID being a third specified ID; a position, in the second indication information, of a first TCI state corresponding to a PDCCH candidate associated with the sixth indication information; a first TCI state corresponding to a PDCCH candidate associated with the sixth indication information is a first TCI state located at a specified position in the second indication information; or a TCI state set to which a first TCI state corresponding to a PDCCH candidate associated with the sixth indication information belongs.

Optionally, the third specified ID is a largest ID among IDs of the multiple first TCI states, or a smallest ID among IDs of the multiple first TCI states. Alternatively, the third specified ID may be the second largest ID or the second smallest ID among the IDs of the multiple first TCI states, which is not limited in the embodiments of the present disclosure. That is to say, the sixth indication information may indicate that the first TCI state corresponding to the current PDCCH candidate is the first TCI state with the largest ID among the multiple TCI states, or the sixth indication information may indicate that the first TCI state corresponding to the current PDCCH candidate is the first TCI state with the smallest ID among the multiple TCI states.

Optionally, the specified position may be the frontmost position in the second indication information or the rearmost position in the second indication information, which is not limited in the embodiments of the present disclosure. That is to say, the sixth indication information may indicate that the first TCI state corresponding to the current PDCCH candidate is the first TCI state at the frontmost position in the second indication information, or the sixth indication information may indicate that the first TCI state corresponding to the current PDCCH candidate is the first TCI state at the rearmost position in the second indication information.

Optionally, the number of TCI state sets includes multiple. The multiple TCI state sets may be configured by the network device or may be determined according to a predefined rule, which is not limited in the embodiments of the present disclosure.

Optionally, the network device may divide the TCI states in the first TCI state group into multiple TCI state sets. Specifically, the network device may include set indication information in the configuration information of each TCI state, and the set indication information is used for indicating a TCI state set to which each TCI state belongs. It is to be understood that the network device may indicate, through the sixth indication information, that the first TCI state corresponding to the current PDCCH candidate is the first TCI state belonging to the indicated TCI state set among the multiple first TCI states.

Optionally, the sixth indication information may include multiple indication values, and the different indication values may indicate different first TCI states corresponding to the PDCCH candidate associated with the sixth indication information. In addition, the network device may indicate different first TCI states corresponding to the PDCCH candidate associated with the sixth indication information by configuring the sixth indication information or not configuring the sixth indication information for the PDCCH candidate.

Exemplarily, the search space for repeatedly transmitting the first PDCCH includes a search space 1 and a search space 2. The search space 1 corresponds to the CORESET1 and the search space 2 corresponds to the CORESET2. The network device configures two first TCI states: a first TCI state 1 and a first TCI state 2. The ID corresponding to the first TCI state 1 is represented by T-ID1, and the ID corresponding to the first TCI state 2 is represented by T-ID2. Specifically, the terminal device may determine correspondences between the multiple PDCCH candidates and the multiple first TCI states in following manner B1 to B10.

In the manner B1, the PDCCH candidate corresponding to the search space with the smallest search space ID corresponds to the first TCI state with the smallest ID, and the PDCCH candidate corresponding to the search space with the largest (or second smallest) search space ID corresponds to the first TCI state with the largest ID. If SS-ID1<SS-ID2 and T-ID1<T-ID2, the PDCCH candidate corresponding to the search space indicated by SS-ID1 corresponds to the first TCI state corresponding to T-ID1, and the PDCCH candidate corresponding to the search space indicated by SS-ID2 corresponds to the first TCI state corresponding to T-ID2.

In the manner B2, the PDCCH candidate corresponding to the search space with the largest search space ID corresponds to the first TCI state with the smallest ID, and the PDCCH candidate corresponding to the search space with the smallest (or second largest) search space ID corresponds to the first TCI state with the largest ID. If SS-ID1>SS-ID2 and T-ID1<T-ID22, the PDCCH candidate corresponding to the search space indicated by SS-ID1 corresponds to the first TCI state corresponding to T-ID1, and the PDCCH candidate corresponding to the search space indicated by SS-ID2 corresponds to the first TCI state corresponding to T-ID2.

In the manner B3, the PDCCH candidate corresponding to the CORESET with the smallest CORESET ID corresponds to the first TCI state with the smallest ID, and the PDCCH candidate corresponding to the CORESET with the largest (or the second smallest) CORESET ID corresponds to the first TCI state with the largest ID. If C-ID1<C-ID2 and T-ID1<T-ID2, the PDCCH candidate corresponding to the search space indicated by C-ID1 corresponds to the first TCI state corresponding to T-ID1, and the PDCCH candidate corresponding to the search space indicated by C-ID2 corresponds to the first TCI state corresponding to T-ID2.

In the manner B4, the PDCCH candidate corresponding to the CORESET with the largest CORESET ID corresponds to the first TCI state with the smallest ID, and the PDCCH candidate corresponding to the CORESET with the smallest (or the second largest) CORESET ID corresponds to the first TCI state with the largest ID. If C-ID1>C-ID2 and T-ID1<T-ID2, the PDCCH candidate corresponding to the search space indicated by C-ID1 corresponds to the first TCI state corresponding to T-ID1, and the PDCCH candidate corresponding to the search space indicated by C-ID2 corresponds to the first TCI state corresponding to T-ID2.

In the manner B5, the PDCCH candidate corresponding to the CORESET with the smallest CORESET ID corresponds to the first TCI state at the front position in the second indication information, and the PDCCH candidate corresponding to the CORESET with the largest (or second smallest) CORESET ID corresponds to the first TCI state at the rear position in the second indication information.

In the manner B6, the PDCCH candidate corresponding to the CORESET with the largest CORESET ID corresponds to the first TCI state at the front position in the second indication information, and the PDCCH candidate corresponding to the CORESET with the smallest (or second largest) CORESET ID corresponds to the first TCI state at the rear position in the second indication information.

In the manner B7, the PDCCH candidate corresponding to the search space with the smallest search space ID corresponds to the first TCI state at the front position in the second indication information, and the PDCCH candidate corresponding to the search space with the largest (or second smallest) search space ID corresponds to the first TCI state at the rear position in the second indication information.

In the manner B8, the PDCCH candidate corresponding to the search space with the largest search space ID corresponds to the first TCI state at the front position in the second indication information, and the PDCCH candidate corresponding to the search space with the smallest (or second largest) search space ID corresponds to the first TCI state at the rear position in the second indication information

In the manner B9, the terminal device determines a first TCI state corresponding to each PDCCH candidate based on the fifth indication information sent by the network device.

Optionally, when the value of the fifth indication information is b1 (such as, 0 or 1), the terminal device determines the first TCI state corresponding to each PDCCH candidate according to the manner B1; and when the value of the fifth indication information is b2 (such as, 1 or 0), the terminal device determines the first TCI state corresponding to each PDCCH candidate according to the manner B2.

Optionally, when the network device configures or indicates the fifth indication information, the terminal device determines the first TCI state corresponding to each PDCCH candidate according to the manner B1; and when the network device does not configure or indicate the fifth indication information, the terminal device determines the first TCI state corresponding to each PDCCH candidate according to the manner B2. Conversely, when the network device configures or indicates the fifth indication information, the terminal device determines the first TCI state corresponding to each PDCCH candidate according to the manner B2; and when the network device does not configure or indicate the fifth indication information, the terminal device determines the first TCI state corresponding to each PDCCH candidate according to the manner B1. Compared with the method that the fifth indication information directly indicates bl and b2, the signaling overhead can be reduced by configuring or not configuring the fifth indication information to indicate the first TCI state corresponding to each PDCCH candidate.

Optionally, when the value of the fifth indication information is b3 (such as, 0 or 1), the terminal device determines the first TCI state corresponding to each PDCCH candidate according to the manner B3; and when the value of the fifth indication information is b4 (such as, 1 or 0), the terminal device determines the first TCI state corresponding to each PDCCH candidate according to the manner B4.

Optionally, when the network device configures or indicates the fifth indication information, the terminal device determines the first TCI state corresponding to each PDCCH candidate according to the manner B3; and when the network device does not configure or indicate the fifth indication information, the terminal device determines the first TCI state corresponding to each PDCCH candidate according to the manner B4. Conversely, when the network device configures or indicates the fifth indication information, the terminal device determines the first TCI state corresponding to each PDCCH candidate according to the manner B4; and when the network device does not configure or indicate the fifth indication information, the terminal device determines the first TCI state corresponding to each PDCCH candidate according to the manner B3. Compared with the method that the fifth indication information directly indicates b3 and b4, the signaling overhead can be reduced by configuring or not configuring the fifth indication information to indicate the first TCI state corresponding to each PDCCH candidate.

Optionally, when the value of the fifth indication information is b5 (such as, 0 or 1), the terminal device determines the first TCI state corresponding to each PDCCH candidate according to the manner B1; and when the value of the fifth indication information is b6 (such as, 1 or 0), the terminal device determines the first TCI state corresponding to each PDCCH candidate according to the manner B3.

Optionally, when the network device configures or indicates the fifth indication information, the terminal device determines the first TCI state corresponding to each PDCCH candidate according to the manner B1; and when the network device does not configure or indicate the fifth indication information, the terminal device determines the first TCI state corresponding to each PDCCH candidate according to the manner B3. Conversely, when the network device configures or indicates the fifth indication information, the terminal device determines the first TCI state corresponding to each PDCCH candidate according to the manner B3; and when the network device does not configure or indicate the fifth indication information, the terminal device determines the first TCI state corresponding to each PDCCH candidate according to the manner B1. Compared with the method that the fifth indication information directly indicates b5 and b6, the signaling overhead can be reduced by configuring or not configuring the fifth indication information to indicate the first TCI state corresponding to each PDCCH candidate.

Optionally, when the value of the fifth indication information is b7 (such as, 0 or 1), the terminal device determines the first TCI state corresponding to each PDCCH candidate according to the manner B2; and when the value of the fifth indication information is b8 (such as, 1 or 0), the terminal device determines the first TCI state corresponding to each PDCCH candidate according to the manner B4.

Optionally, when the network device configures or indicates the fifth indication information, the terminal device determines the first TCI state corresponding to each PDCCH candidate according to the manner B2; and when the network device does not configure or indicate the fifth indication information, the terminal device determines the first TCI state corresponding to each PDCCH candidate according to the manner B4. Conversely, when the network device configures or indicates the fifth indication information, the terminal device determines the first TCI state corresponding to each PDCCH candidate according to the manner B4; and when the network device does not configure or indicate the fifth indication information, the terminal device determines the first TCI state corresponding to each PDCCH candidate according to the manner B2. Compared with the method that the fifth indication information directly indicates b7 and b8, the signaling overhead can be reduced by configuring or not configuring the fifth indication information to indicate the first TCI state corresponding to each PDCCH candidate.

Optionally, when the value of the fifth indication information is b9 (such as, 0 or 1), the terminal device determines the first TCI state corresponding to each PDCCH candidate according to the manner B5; and when the value of the fifth indication information is b10 (such as, 1 or 0), the terminal device determines the first TCI state corresponding to each PDCCH candidate according to the manner B6.

Optionally, when the network device configures or indicates the fifth indication information, the terminal device determines the first TCI state corresponding to each PDCCH candidate according to the manner B5; and when the network device does not configure or indicate the fifth indication information, the terminal device determines the first TCI state corresponding to each PDCCH candidate according to the manner B6. Conversely, when the network device configures or indicates the fifth indication information, the terminal device determines the first TCI state corresponding to each PDCCH candidate according to the manner B6; and when the network device does not configure or indicate the fifth indication information, the terminal device determines the first TCI state corresponding to each PDCCH candidate according to the manner B5. Compared with the method that the fifth indication information directly indicates b9 and b10, the signaling overhead can be reduced by configuring or not configuring the fifth indication information to indicate the first TCI state corresponding to each PDCCH candidate.

In a manner B10, the terminal device determines, based on two pieces of sixth indication information (sixth indication information 1 and sixth indication information 2, respectively) sent by the network device, the first TCI state corresponding to the PDCCH candidate in the search space 1 and the first TCI state corresponding to the PDCCH candidate in the search space 2, respectively.

Optionally, the sixth indication information 1 sent by the network device may be contained in the configuration information of the search space 1, and the sixth indication information 2 sent by the network device may be contained in the configuration information of the search space 2.

Optionally, the sixth indication information 1 sent by the network device may be contained in the configuration information of the CORESET 1 corresponding to the search space 1, and the sixth indication information 2 sent by the network device may be contained in the configuration information of the CORESET 2 corresponding to the search space 2.

Optionally, when the value of the sixth indication information 1 is c1, the first TCI state corresponding to the PDCCH candidate in the search space 1 is a TCI state A; and when the value of the sixth indication information 1 is c2, the first TCI state corresponding to the PDCCH candidate in the search space 1 is a TCI state B.

Alternatively, when the network device configures or indicates the sixth indication information 1, the first TCI state corresponding to the PDCCH candidate in the search space 1 is a TCI state A; and when the network device does not configure or indicate the sixth indication information 1, the first TCI state corresponding to the PDCCH candidate in the search space 1 is a TCI state B.

The TCI state A and the TCI state B may be any one of the following: the TCI state A is a first TCI state with the smallest ID among the first TCI state 1 and the first TCI state 2, and the TCI state B is a first TCI state with the largest ID among the first TCI state 1 and the first TCI state 2; the TCI state A is a first TCI state with the largest ID among the first TCI state 1 and the first TCI state 2, and the TCI state B is a first TCI state with the smallest ID among the first TCI state 1 and the first TCI state 2; the TCI state A is a first TCI state at a front position in the second indication information among the first TCI 1 and the first TCI state 2, and the TCI state B is a first TCI state at a rear position in the second indication information among the first TCI 1 and the first TCI state 2; the TCI state A is a first TCI state at the rear position in the second indication information among the first TCI 1 and the first TCI state 2, and the TCI state B is a first TCI state at the front position in the second indication information among the first TCI 1 and the first TCI state 2; or the TCI state A is a first TCI state belonging to a first TCI state set among the first TCI 1 and the first TCI state 2, and the TCI state B is a first TCI state belonging to a second TCI state set among the first TCI 1 and the first TCI state 2.

The first TCI state set and the second TCI state set may be determined according to a predefined rule, or according to a configuration of the network.

Exemplarily, the network may divide the TCI states in the first TCI state group into the first TCI state set and the second TCI state set, and may include set indication information in the configuration information of the TCI state, where the set indication information indicates whether the TCI state belongs to the first TCI state set or the second TCI state set.

Optionally, the sixth indication information 2 is similar to the sixth indication information 1 in the indication manner, which will not be repeated here for the sake of simplicity.

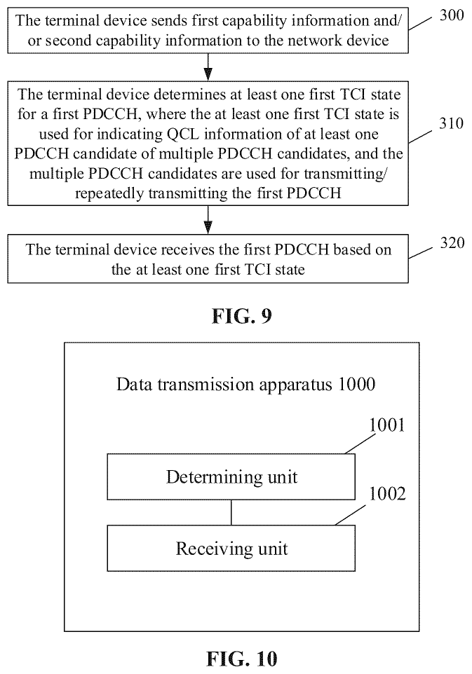

In the embodiment of the present disclosure, with reference to FIG. 9, the method further includes an operation 300.

In operation 300, the terminal device sends first capability information and/or second capability information to the network device.

The first capability information is used for indicating that the terminal device supports multiple unified TCI states to be simultaneously used for DL transmission (or DL operation/DL reception), and/or that the terminal device supports that a codepoint in a DCI indicates multiple unified TCI states for DL transmission; and the second capability information is used for indicating that the terminal device supports PDCCH repetition, and/or that the terminal device supports linking among multiple search spaces.

It is to be understood that the first capability information may indicate that the terminal device supports Z (where Z>1) unified TCI states to be simultaneously used for the DL transmission or DL reception; or that the terminal device supports one codepoint in the information field “Transmission configuration indication” of the DCI to activate or indicate at most Z unified TCI states for the DL transmission or the DL reception.

Optionally, Z may have a value of 2, 4, or other numerical values, which is not limited in the embodiments of the present disclosure.

Furthermore, the second capability information may indicate the PDCCH repetition by the terminal device, and/or indicate that the terminal device supports linking among multiple (2 or more) search spaces.

Optionally, the terminal device may send the first capability information and/or the second capability information to the network device before operation 310, so that the network device may configure unified TCI state(s) for the multi-TRP/panel/beam PDCCH repetition by the terminal device based on the first capability information and/or the second capability information reported by the terminal device.

Optionally, the first capability information and/or the second capability information are capabilities for any one of the following objects: the terminal device; a carrier; a band; a band combination; a band combination and a band in the band combination; a band combination and a carrier per band in the band combination; or a frequency range.

Optionally, the first capability information and/or the second capability information may be reported per band. That is to say, the corresponding first capability information and/or second capability information may be reported separately for different bands. For example, the terminal device may support the first capability information and/or the second capability information in a certain band or in certain bands, and the terminal device does not support the first capability information and/or the second capability information in other bands. By separately reporting the first capability information and/or the second capability information for different bands, the terminal device can enjoy greater flexibility, and moreover, more terminal devices can support the unified TCI state configuration in the multi-TRP/panel/beam PDCCH repetition scenario.

Optionally, the first capability information and/or the second capability information may be separately reported per band combination. For example, the terminal device may not report the first capability information and/or the second capability information in a certain band combination, but may report the first capability information and/or the second capability information in another band combination. It is to be understood that separate reporting for different band combinations can provide the terminal with greater flexibility, and moreover, enable more terminal devices to support the unified TCI state configuration in the multi-TRP/panel/beam PDCCH repetition scenario.

Optionally, the first capability information and/or the second capability information may be separately reported per band per band combination. That is to say, the separate reporting may be performed for bands in different band combinations. For example, the terminal device may not support the first capability information and/or the second capability information in a certain CA, but may report the first capability information and/or the second capability information in some bands in another CA combination. It is to be understood that separate reporting for different band combinations can provide the terminal with greater flexibility, and moreover, enable more terminal devices to support the unified TCI state configuration in the multi-TRP/panel/beam PDCCH repetition scenario.

Optionally, the first capability information and/or the second capability information may be separately reported per CC per band per band combination. That is to say, the separate reporting may be performed for different carries (component carriers, CCs) in bands in different band combinations, or FSPC. It is to be understood that separate reporting for different band combinations and separate reporting for different CCs in one band can provide the terminal device with greater flexibility, and moreover, enable more terminal devices to support the unified TCI state configuration in the multi-TRP/panel/beam PDCCH repetition scenario.

Optionally, the first capability information and/or the second capability information may be reported per frequency range. That is to say, the separate reporting is performed for different FRs (for example, FR1 with a low frequency and FR2 with a high frequency). It is to be understood that separate reporting for different FRs can provide the terminal with greater flexibility, and moreover, enable more terminal devices to support the unified TCI state configuration in the multi-TRP/panel/beam PDCCH repetition scenario.

Optionally, the first capability information and/or the second capability information may be reported per terminal device. That is to say, if the terminal device (i.e., a UE) reports the first capability information and/or the second capability information, it indicates that the terminal device may support the first capability information and/or the second capability information in each band, which can reduce the overhead of the signaling for the terminal to report the capability.

Optionally, the first capability information and the second capability information may be reported for different objects. For example, one of the first capability information and the second capability information is reported per band and the other is reported per CC per band per band combination. Since the UL and DL have different capability requirements for the terminal device, different capability options are used for the UL and the DL, which can be more conducive to the implementation by the terminal device.

Optionally, the first capability information and/or the second capability information may be transmitted by a RRC signaling or a MAC CE signaling. The first capability information and the second capability information may be the same and may be transmitted by one signaling; or the first capability information and the second capability information may be different and may be transmitted by different signalings, which is not limited in the embodiments of the present disclosure.

Preferred embodiments of the present disclosure have been described in detail with reference to the accompanying drawings, but the present disclosure is not limited to the specific details of the above embodiments. Within the scope of the technical conception of the present disclosure, various simple modifications may be made to the technical scheme of the present disclosure, and these simple modifications all fall within the scope of protection of the present disclosure. For example, each of the specific technical features described in the above specific embodiments may be combined in any suitable manner without contradiction, and various possible combinations are not further described in this disclosure in order to avoid unnecessary repetition. For another example, any combination may be made between the various embodiments of the present disclosure so long as it does not depart from the idea of the present disclosure and is also to be regarded as the present disclosure of the present disclosure. For another example, on the premise of no conflict, each embodiment described in the present disclosure and/or the technical features in each embodiment may be arbitrarily combined with the prior art, and the technical scheme obtained after the combination should also fall within the scope of protection of the present disclosure.

It is to be understood that, in various embodiments of the present disclosure, the sequence numbers of the above processes do not imply the sequence of execution, and the sequence of execution of each process is to be determined according to its functions and internal logic, and should not constitute any limitation on the implementation process of the embodiments of the present disclosure. Furthermore, in embodiments of the present disclosure, the terms “downlink”, “uplink” and “sidelink” are used to represent the transmission direction of the signal or data, where the term “downlink” is used to represent a transmission direction of the signal or data as a first direction from a site to the user equipment in the cell, the term “uplink” is used to represent a transmission direction of the signal or data as a second direction from the user equipment in the cell to the site, and the term “sidelink” is used to represent a transmission direction of the signal or data as a first direction from the user equipment 1 to the user equipment 2. For example, a term “downlink signal” means that the transmission direction of the signal is a first direction. In addition, in embodiments of the present disclosure, the term “and/or” is only an association relationship describing associated objects and represents that three relationships may exist. For example, A and/or B may represent three conditions: i.e., independent existence of A, existence of both A and B and independent existence of B. In addition, the character “/” in the present disclosure generally indicates that the relationship between the associated objects is “or”.

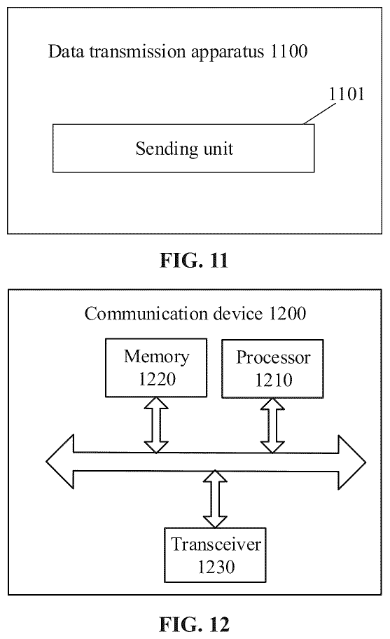

FIG. 10 is a first schematic structural diagram of a data transmission apparatus 1000 according to an embodiment of the present disclosure, which is applied to a terminal device. As illustrated in FIG. 10, the data transmission apparatus includes a determining unit 1001 and a receiving unit 1002.

The determining unit 1001 is configured to determine at least one first TCI state for a first PDCCH, where the at least one first TCI state is used for indicating QCL information of at least one PDCCH candidate of multiple PDCCH candidates, and the multiple PDCCH candidates are used for transmitting/repeatedly transmitting the first PDCCH.

The receiving unit 1002 is configured to receive the first PDCCH based on the at least one first TCI state.

Optionally, the receiving unit 1002 is further configured to receive first indication information sent by a network device, where the first indication information is used for indicating at least one TCI state of multiple available TCI states, and the at least one TCI state includes the at least one first TCI state.

Optionally, the receiving unit 1002 is further configured to receive second indication information sent by the network device, where the second indication information is used for configuring multiple available TCI states including the at least one first TCI state.

Optionally, the multiple PDCCH candidates are PDCCH candidates in multiple search spaces, respectively, and a linking relationship exists among the multiple search spaces.

Optionally, the multiple search spaces correspond to multiple CORESETs.

Optionally, the at least one first TCI state is used for indicating QCL information of PDCCH candidate(s) corresponding to at least one search space of the multiple search spaces.

Optionally, the at least one first TCI state is used for indicating QCL information of PDCCH candidate(s) corresponding to at least one CORESET of the multiple CORESETs.

Optionally, where a number of the at least one first TCI state includes one, and the receiving unit 1002 is further configured to receive the first PDCCH through a PDCCH candidate corresponding to a first search space, where QCL information of the PDCCH candidate corresponding to the first search space is determined by the first TCI state, and the first search space is any one of the multiple search spaces.

Optionally, the first search space is determined according to any one of: the first search space is a search space with a search space ID being a first specified ID among the multiple search spaces; the first search space is a search space corresponding to a CORESET with a CORESET ID being a second specified ID among multiple CORESETs, where the multiple CORESETs correspond to the multiple search spaces; or the first search space is determined based on third indication information sent by the network device.

Optionally, the third indication information is used for indicating any one of: a search space ID of the first search space; a CORESET ID of a CORESET corresponding to the first search space; the first search space being the search space with the search space ID being the first specified ID among the multiple search spaces; or the first search space being the search space corresponding to the CORESET with the CORESET ID being the second specified ID among the multiple CORESETs.

Optionally, the first specified ID is a smallest search space ID among search space IDs of the multiple search spaces, or a largest search space ID among search space IDs of the multiple search spaces; and the second specified ID is a smallest CORESET ID among CORESET IDs of the multiple CORESETs, or a largest CORESET ID among CORESET IDs of the multiple CORESETs.

Optionally, the third indication information is carried through a RRC signaling or a MAC CE signaling.

Optionally, a number of the at least one first TCI state includes one, and the receiving unit 1002 is further configured to receive the first PDCCH through PDCCH candidates respectively corresponding to the multiple search spaces, where the QCL information of the PDCCH candidate corresponding to each of the multiple search spaces is determined by the first TCI state.

Optionally, a number of the at least one first TCI state includes one, and the receiving unit 1002 is further configured to receive fourth indication information sent by the network device, where the fourth indication information is used for instructing the terminal device to receive the first PDCCH through a PDCCH candidate corresponding to a first search space, or the fourth indication information is used for instructing the terminal device to receive the first PDCCH through PDCCH candidates respectively corresponding to the multiple search spaces, where the first search space is any one of the multiple search spaces.

Optionally, the receiving unit 1002 is further configured to perform any one of: when a value of the fourth indication information is a first value, receiving the first PDCCH through the PDCCH candidate corresponding to the first search space, where QCL information of the PDCCH candidate corresponding to the first search space is determined by the first TCI state; when the value of the fourth indication information is a second value, receiving the first PDCCH through the PDCCH candidates respectively corresponding to the multiple search spaces, where QCL information of a PDCCH candidate corresponding to each of the multiple search spaces is determined by the first TCI state; when the fourth indication information is configured by the network device, receiving the first PDCCH through the PDCCH candidate corresponding to the first search space, and when the fourth indication information is not configured by the network device, receiving the first PDCCH through the PDCCH candidates respectively corresponding to the multiple search spaces; or when the fourth indication information is not configured by the network device, receiving the first PDCCH through the PDCCH candidate corresponding to the first search space, and when the fourth indication information is configured by the network device, receiving the first PDCCH through the PDCCH candidates respectively corresponding to the multiple search spaces.

Optionally, the fourth indication information is carried through a RRC signaling or a MAC CE signaling.

Alternatively, a number of the at least one first TCI state includes multiple, and the receiving unit 1002 is further configured to receive the first PDCCH through the multiple PDCCH candidates, where QCL information of the multiple PDCCH candidates is determined by the multiple first TCI states.

Optionally, the determining unit 1001 may be configured to perform any one of: determining a first TCI state corresponding to a PDCCH candidate in each of the multiple search spaces based on a size order of search space IDs of the multiple search spaces and a size order of IDs of the multiple first TCI states; determining the first TCI state corresponding to the PDCCH candidate in each of the multiple search spaces based on the size order of the search space IDs of the multiple search spaces and positions of the multiple first TCI states in the second indication information; determining a first TCI state corresponding to a PDCCH candidate in each of the multiple CORESETs based on a size order of CORESET IDs of the multiple CORESETs and the size order of the IDs of the multiple first TCI states; determining the first TCI state corresponding to the PDCCH candidate in each of the multiple CORESETs based on the size order of the CORESET IDs of the multiple CORESETs and the positions of the multiple first TCI states in the second indication information; determining correspondences between the multiple PDCCH candidates and the multiple first TCI states based on fifth indication information sent by the network device; or determining the first TCI states corresponding to the multiple PDCCH candidates, respectively, based on multiple pieces of sixth indication information sent by the network device, with the multiple pieces of sixth indication information being associated with the multiple PDCCH candidates.

Optionally, the fifth indication information is used for indicating any one of: determining a first TCI state corresponding to a PDCCH candidate in each of the multiple search spaces based on a size order of search space IDs of the multiple search spaces and a size order of IDs of the multiple first TCI states; determining the first TCI state corresponding to the PDCCH candidate in each of the multiple search spaces based on the size order of the search space IDs of the multiple search spaces and positions of the multiple first TCI states in the second indication information; determining a first TCI state corresponding to a PDCCH candidate in each of the multiple CORESETs based on a size order of CORESET IDs of the multiple CORESETs and the size order of the IDs of the multiple first TCI states; or determining the first TCI state corresponding to the PDCCH candidate in each of the multiple CORESETs based on the size order of the CORESET IDs of the multiple CORESETs and the positions of the multiple first TCI states in the second indication information.

Optionally, the fifth indication information is carried through a RRC signaling or a MAC CE signaling.

Optionally, each of the multiple pieces of sixth indication information is used for indicating any one of: an ID of a first TCI state corresponding to a PDCCH candidate associated with the sixth indication information; the first TCI state corresponding to the PDCCH candidate associated with the sixth indication information being a first TCI state with an ID being a third specified ID; a position, in the second indication information, of the first TCI state corresponding to the PDCCH candidate associated with the sixth indication information; the first TCI state corresponding to the PDCCH candidate associated with the sixth indication information being a first TCI state located at a specified position in the second indication information; or a TCI state set to which the first TCI state corresponding to the PDCCH candidate associated with the sixth indication information belongs.

Optionally, the third specified ID is a largest ID among IDs of the multiple first TCI states, or a smallest ID among IDs of the multiple first TCI states; and the specified position is the first one of positions of the multiple first TCI states in the second indication information, or the last one of positions of the multiple first TCI states in the second indication information.

Optionally, each piece of sixth indication information is carried through configuration information of a search space for a PDCCH associated with the sixth indication information, or carried through configuration information of a CORESET corresponding to a search space for a PDCCH associated with the sixth indication information.

Optionally, the first indication information is carried through any one of: a RRC signaling, a MAC CE signaling, or a DCI.

Optionally, the second indication information is carried through a first MAC CE signaling.

Optionally, the first MAC CE signaling includes at least one of: DL BWP indication information; UL BWP indication information; at least one TCI number indication information, where each of the at least one TCI number indication information is used for indicating a number of TCI states associated with the TCI number indication information; at least one TCI type indication information, for indicating types of the multiple available TCI states; or configuration information of the multiple available TCI states.

Optionally, the receiving unit 1002 is further configured to receive seventh indication information sent by the network device, where the seventh indication information is used for indicating that a type of a unified TCI state is a joint TCI state, and the at least one first TCI state is the joint TCI state; or receive eighth indication information sent by the network device, where the eighth indication information is used for indicating that a type of a unified TCI state is a separate TCI state, and the at least one first TCI state is a DL TCI state.

Optionally, the data transmission apparatus further includes a sending unit configured to send first capability information and/or second capability information to the network device, where the first capability information is used for indicating that the terminal device supports multiple unified TCI states to be simultaneously used for DL transmission, and/or that the terminal device supports a codepoint in a DCI to indicate the multiple unified TCI states for the DL transmission; and the second capability information is used for indicating that the terminal device supports PDCCH repetition, and/or that the terminal device supports linking among multiple search spaces.

Optionally, the first capability information and/or the second capability information are capabilities for any one of the following objects: the terminal device; a carrier; a band; a band combination; a band combination and a band in the band combination; a band combination and a carrier per band in the band combination; or a frequency range.

FIG. 11 is a second schematic structural diagram of a data transmission apparatus 1100 according to an embodiment of the present disclosure, which is applied to a network device. As illustrated in FIG. 11, the data transmission apparatus includes a sending unit 1101.

The sending unit 1101 is configured to transmit, through at least one PDCCH candidate of multiple PDCCH candidates, a first PDCCH to a terminal device, where the multiple PDCCH candidates are used for transmitting or repeatedly transmitting the first PDCCH, and QCL information of the at least one PDCCH candidate is determined by at least one first TCI state for the first PDCCH.

Optionally, the sending unit 1101 is further configured to send first indication information to the terminal device, where the first indication information is used for indicating at least one TCI state of multiple available TCI states, and the at least one TCI state includes the at least one first TCI state for the first PDCCH.

Optionally, the sending unit 1101 is further configured to send second indication information to the terminal device, where the second indication information is used for configuring multiple available TCI states including the at least one first TCI state.

Optionally, the multiple PDCCH candidates are PDCCH candidates in multiple search spaces, respectively, and a linking relationship exists among the multiple search spaces.

Optionally, the multiple search spaces correspond to multiple CORESETs.

Optionally, the at least one first TCI state is used for indicating QCL information of PDCCH candidate(s) corresponding to at least one search space of the multiple search spaces.

Optionally, the at least one first TCI state is used for indicating QCL information of PDCCH candidate(s) corresponding to at least one CORESET of the multiple CORESETs.

Optionally, a number of the at least one first TCI state includes one, and the sending unit 1101 is further configured to transmit the first PDCCH through a PDCCH candidate corresponding to a first search space, where QCL information of the PDCCH candidate corresponding to the first search space is determined by the first TCI state, and the first search space is any one of the multiple search spaces.

Optionally, the first search space is determined according to any one of: the first search space is a search space with a search space ID being a first specified ID among the multiple search spaces; or the first search space is a search space corresponding to a CORESET with a CORESET ID being a second specified ID among the multiple CORESETs.

Optionally, the sending unit 1101 is further configured to transmit third indication information to the terminal device, where the third indication information is used for indicating any one of: a search space ID of the first search space; a CORESET ID of a CORESET corresponding to the first search space; the first search space being the search space with the search space ID being the first specified ID among the multiple search spaces; or the first search space being the search space corresponding to the CORESET with the CORESET ID being the second specified ID among the multiple CORESETs.

Optionally, the first specified ID is a smallest search space ID among search space IDs of the multiple search spaces, or a largest search space ID among search space IDs of the multiple search spaces. The second specified ID is a smallest CORESET ID among CORESET IDs of the multiple CORESETs, or a largest CORESET ID among CORESET IDs of the multiple CORESETs.

Optionally, the third indication information is carried through a RRC signaling or a MAC CE signaling.

Optionally, a number of the at least one first TCI state includes one, and the sending unit 1101 is further configured to repeatedly transmit the first PDCCH through PDCCH candidates respectively corresponding to the multiple search spaces, where QCL information of a PDCCH candidate corresponding to each of the multiple search spaces is determined by the first TCI state.

Optionally, a number of the at least one first TCI state includes one, and the sending unit 1101 is further configured to send fourth indication information to the terminal device, where the fourth indication information is used for instructing the terminal device to receive the first PDCCH through a PDCCH candidate corresponding to a first search space, or the fourth indication information is used for instructing the terminal device to receive the first PDCCH through PDCCH candidates respectively corresponding to the multiple search spaces, where the first search space is any one of the multiple search spaces.

Optionally, when a value of the fourth indication information is a first value, the terminal device is instructed to receive the first PDCCH through the PDCCH candidate corresponding to the first search space, where QCL information of the PDCCH candidate corresponding to the first search space is determined by the first TCI state; and when the value of the fourth indication information is a second value, the terminal device is instructed to receive the first PDCCH through the PDCCH candidates respectively corresponding to the multiple search spaces, where QCL information of a PDCCH candidate corresponding to each of the multiple search spaces is determined by the first TCI state.

Optionally, when the fourth indication information is configured by the network device, the terminal device is instructed to receive the first PDCCH through the PDCCH candidate corresponding to the first search space, and when the fourth indication information is not configured by the network device, the terminal device is instructed to receive the first PDCCH through the PDCCH candidates respectively corresponding to the multiple search spaces; or, when the fourth indication information is not configured by the network device, the terminal device is instructed to receive the first PDCCH through the PDCCH candidate corresponding to a first search space, and when the fourth indication information is configured by the network device, the terminal device is instructed to receive the first PDCCH through the PDCCH candidates respectively corresponding to the multiple search spaces.

Optionally, the fourth indication information is carried through a RRC signaling or a MAC CE signaling.

Optionally, a number of the at least one first TCI state includes multiple, and the sending unit 1101 is further configured to repeatedly transmit the first PDCCH through the multiple PDCCH candidates, where the QCL information of the multiple PDCCH candidates is determined by the multiple first TCI states.

Optionally, a first TCI state corresponding to a PDCCH candidate in each of the multiple search spaces is determined based on a size order of search space IDs of the multiple search spaces and a size order of IDs of the multiple first TCI states; the first TCI state corresponding to the PDCCH candidate in each of the multiple search spaces is determined based on the size order of the search space IDs of the multiple search spaces and positions of the multiple first TCI states in the second indication information; a first TCI state corresponding to a PDCCH candidate in each of the multiple CORESETs is determined based on a size order of CORESET IDs of the multiple CORESETs and the size order of the IDs of the multiple first TCI states; or the first TCI state corresponding to the PDCCH candidate in each of the multiple CORESETs is determined based on the size order of the CORESET IDs of the multiple CORESETs and the positions of the multiple first TCI states in the second indication information.

Optionally, the sending unit 1101 is further configured to send fifth indication information and/or multiple pieces of sixth indication information to the terminal device, where the fifth indication information and/or the multiple pieces of sixth indication information are used for determining correspondences between the multiple PDCCH candidates and the multiple first TCI states.

Optionally, the fifth indication information is used for indicating any one of: the terminal device determining a first TCI state corresponding to a PDCCH candidate in each of the multiple search spaces based on a size order of search space IDs of the multiple search spaces and a size order of IDs of the multiple first TCI states; the terminal device determining the first TCI state corresponding to the PDCCH candidate in each of the multiple search spaces based on the size order of the search space IDs of the multiple search spaces and positions of the multiple first TCI states in the second indication information; the terminal device determining a first TCI state corresponding to a PDCCH candidate in each of the multiple CORESETs based on a size order of CORESET IDs of the multiple CORESETs and the size order of the IDs of the multiple first TCI states; or the terminal device determining the first TCI state corresponding to the PDCCH candidate in each of the multiple CORESETs based on the size order of the CORESET IDs of the multiple CORESETs and the positions of the multiple first TCI states in the second indication information.

Optionally, the fifth indication information is carried through a RRC signaling or a MAC CE signaling.

Optionally, the multiple pieces of sixth indication information are associated with the multiple PDCCH candidates, and each of the multiple pieces of sixth indication information is used for indicating any one of: an ID of a first TCI state corresponding to a PDCCH candidate associated with the sixth indication information; the first TCI state corresponding to the PDCCH candidate associated with the sixth indication information being a first TCI state with an ID being a third specified ID; a position, in the second indication information, of the first TCI state corresponding to the PDCCH candidate associated with the sixth indication information; the first TCI state corresponding to the PDCCH candidate associated with the sixth indication information being a first TCI state located at a specified position in the second indication information; or a TCI state set to which the first TCI state corresponding to the PDCCH candidate associated with the sixth indication information belongs.

Optionally, the third specified ID is a largest ID among IDs of the multiple first TCI states, or a smallest ID among IDs of the multiple first TCI states; and the specified position is the first one of positions of the multiple first TCI states in the second indication information, or the last one of positions of the multiple first TCI states in the second indication information

Optionally, each piece of sixth indication information is carried through configuration information of a search space for a PDCCH associated with the sixth indication information, or carried through configuration information of a CORESET corresponding to the search space for the PDCCH associated with the sixth indication information.

Optionally, the first indication information is carried through any one of: a RRC signaling, a MAC CE signaling, or a DCI.

Optionally, the second indication information is carried through a first MAC CE signaling.

Optionally, the first MAC CE signaling includes at least one of: DL BWP indication information; UL BWP indication information; at least one TCI number indication information, where each of the at least one TCI number indication information is used for indicating a number of TCI states associated with the TCI number indication information; at least one TCI type indication information, for indicating types of the multiple available TCI states; or configuration information of the multiple available TCI states.

Optionally, the sending unit 1101 is further configured to send seventh indication information to the terminal device, where the seventh indication information is used for indicating that a type of a unified TCI state is a joint TCI state, and the at least one first TCI state is the joint TCI state; or send eighth indication information to the terminal device, where the eighth indication information is used for indicating that a type of a unified TCI state is a separate TCI state, and the at least one first TCI state is a DL TCI state.

Optionally, the data transmission apparatus further includes a receiving unit configured to receive first capability information and/or second capability information sent by the terminal device; where the first capability information is used for indicating that the terminal device supports multiple unified TCI states to be simultaneously used for DL transmission, and/or that the terminal device supports a codepoint in a DCI to indicate the multiple unified TCI states for the DL transmission; and the second capability information is used for indicating that the terminal device supports PDCCH repetition, and/or that the terminal device supports linking among multiple search spaces.

Optionally, the first capability information and/or the second capability information are capabilities for any one of the following objects: the terminal device; a carrier; a band; a band combination; a band combination and a band in the band combination; a band combination and a carrier per band in the band combination; or a frequency range.

Those skilled in the art will appreciate that the above-described description of the data transmission apparatuses in the embodiments of the present disclosure may be understood with reference to the description of the data transmission methods in the embodiments of the present disclosure.

FIG. 12 is a schematic structural diagram of a communication device 1200 according to an embodiment of the present disclosure. The communication device may be a terminal device or a network device. The communication device 1200 illustrated in FIG. 12 includes a processor 1210 that may invoke and run a computer program from a memory to implement the methods in the embodiment of the present disclosure.

Optionally, as illustrated in FIG. 12, the communication device 1200 may also include a memory 1220. The processor 1210 may invoke and run a computer program from the memory 1220 to implement the methods in the embodiment of the present disclosure.

The memory 1220 may be a separate device independent of the processor 1210 or the memory 1220 may be integrated into the processor 1210.

Optionally, as illustrated in FIG. 12, the communication device 1200 may also include a transceiver 1230. The processor 1210 may control the transceiver 1230 to communicate with other devices, in particular, to send information or data to other devices, or receive information or data sent by other devices.

The transceiver 1230 may include a transmitter and a receiver. The transceiver 1230 may further include antenna(s), the number of which may be one or more.

Optionally, the communication device 1200 may be specifically a network device in the embodiments of the present disclosure, and the communication device 1200 may implement the corresponding processes implemented by the network device in each method of the embodiments of the present disclosure, which will not be repeated herein for the sake of brevity.

Optionally, the communication device 1200 may be a terminal device according to the embodiments of the present disclosure, and the communication device 1200 may implement the corresponding processes implemented by the terminal device in each method of the embodiments of the present disclosure, which will not be repeated herein for the sake of brevity.

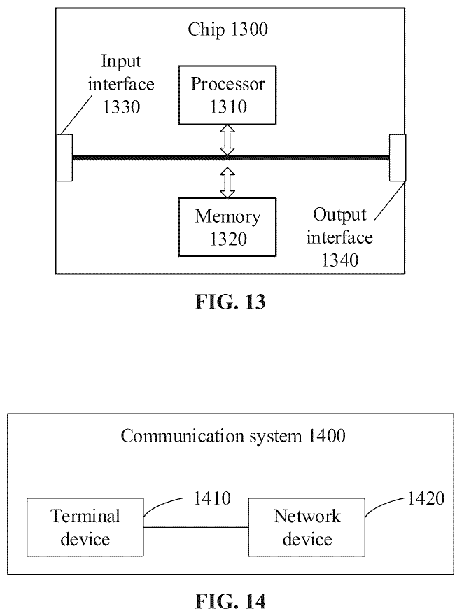

FIG. 13 is a schematic structural diagram of a chip according to an embodiment of the present disclosure. The chip 1300 illustrated in FIG. 13 includes a processor 1310 that may invoke and run a computer program from a memory to implement the methods in the embodiment of the present disclosure.

Optionally, as illustrated in FIG. 13, the chip 1300 may also include a memory 1320. The processor 1310 may invoke and run a computer program from the memory 1320 to implement the methods in the embodiment of the present disclosure.

The memory 1320 may be a separate device independent of the processor 1310 or the memory 1320 may be integrated in the processor 1310.

Optionally, the chip 1300 may also include an input interface 1330. The processor 1300 may control the input interface 1330 to communicate with other devices or chips, and in particular may obtain information or data sent by other devices or chips.

Optionally, the chip 1300 may also include an output interface 1340. The processor 1310 may control the output interface 1340 to communicate with other devices or chips, and in particular may output information or data to other devices or chips.

Optionally, the chip may be applied to the network device in the embodiments of the present disclosure, and the chip may implement the corresponding processes implemented by the network device in each method of the embodiments of the disclosure, which is not repeated herein for the sake of brevity.

Optionally, the chip may be applied to the mobile terminal/terminal device in the embodiments of the present disclosure, and the chip may implement the corresponding processes implemented by the mobile terminal/terminal device in each method of the embodiment of the disclosure, which will not be repeated herein for the sake of brevity

It is to be understood that chips mentioned in the embodiments of the present disclosure may also be referred to as system level chips, system chips, chip systems or on-chip system chips, or the like.

FIG. 14 is a schematic block diagram of a communication system 1400 according to an embodiment of the present disclosure. As illustrated in FIG. 14, the communication system 1400 includes a terminal device 1410 and a network device 1420.

The terminal device 1410 may be configured to implement the corresponding functions implemented by the terminal device in the above methods, and the network device 1420 may be configured to implement the corresponding functions implemented by the network device in the above methods, which will not be repeated herein for the sake of brevity.

It is to be understood that the processor of the embodiments of the disclosure may be an integrated circuit chip with signal processing capacity. In an implementation process, various steps of the above method embodiments may be completed by an integrated logic circuit of hardware in the processor or an instruction in the form of software. The above processor may be a general-purpose processor, a Digital Signal Processor (DSP), an Application Specific Integrated Circuit (ASIC), a Field Programmable Gate Array (FPGA), or other programmable logic devices, discrete gate or transistor logic devices, and discrete hardware components. Various methods, operations, and logical block diagrams disclosed in the embodiments of the disclosure may be implemented or performed. The general-purpose processor may be a microprocessor, any conventional processor, or the like. Operations of the methods disclosed with reference to the embodiments of the disclosure may be directly performed and accomplished by a hardware decoding processor, or may be performed and accomplished by a combination of hardware and software modules in the decoding processor. The software module may be located in a storage medium mature in the art, such as a random access memory, a flash memory, a read-only memory, a programmable read-only memory or electrically erasable programmable memory, or a register. The storage medium is located in the memory, and the processor reads information in the memory and completes the operations in the foregoing methods in combination with hardware of the processor.

It may be understood that the memory in the embodiments of the disclosure may be a volatile memory or a nonvolatile memory, or may include a volatile memory and a nonvolatile memory. The non-volatile memory may be a read-only memory (Read-Only Memory, ROM), a programmable read-only memory (Programmable ROM, PROM), an crasable programmable read-only memory (Erasable PROM, EPROM), an electrically crasable programmable read-only memory (Electrically EPROM, EEPROM), or a flash memory. The volatile memory may be a RAM, which is used as an external high-speed cache. By way of example but not restrictive description, many forms of RAMs may be used, for example, a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), and a Direct Rambus RAM (DR RAM). It is to be noted that the memory of the systems and methods described in this specification includes but is not limited to these and any other proper types of memories.

It is to be understood that the abovementioned memories are exemplary but not restrictive, for example, the memory in the embodiments of the disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a Direct Rambus RAM (DR RAM). That is to say, the memories described in the embodiment of the disclosure are intended to include, but not limited to, these and any other suitable types of memories.

The embodiments of the disclosure further provide a computer-readable storage medium, which is configured to store a computer program.

Optionally, the computer-readable storage medium may be applied to the network device in the embodiments of the disclosure. The computer program enables a computer to execute corresponding flows implemented by the network device in each method of the embodiments of the disclosure, which will not be elaborated here for simplicity.

Optionally, the computer-readable storage medium may be applied to the terminal device in the embodiments of the disclosure. The computer program enables a computer to execute corresponding flows implemented by the terminal device in each method of the embodiments of the disclosure, which will not be elaborated here for simplicity.

The embodiments of the disclosure further provide a computer program product, which includes a computer program instruction.

Optionally, the computer program product may be applied to the network device in the embodiments of the disclosure. The computer program instruction enables a computer to execute corresponding flows implemented by the network device in each method of the embodiments of the disclosure, which will not be elaborated here for simplicity. Optionally, the computer program product may be applied to the terminal device in the embodiments of the disclosure. The computer program instruction enables a computer to execute corresponding flows implemented by the terminal device in each method of the embodiments of the disclosure, which will not be elaborated here for simplicity.

The embodiments of the disclosure further provide a computer program. Optionally, the computer program may be applied to the network device in the embodiments of the disclosure. When the computer program is executed on a computer, the computer program enables the computer to perform corresponding flows implemented by the network device in each method of the embodiments of the disclosure, which will not be elaborated here for simplicity. Optionally, the computer program may be applied to the terminal device in the embodiments of the disclosure. When the computer program is executed on a computer, the computer program enables the computer to perform corresponding flows implemented by the terminal device in each method of the embodiments of the disclosure, which will not be elaborated here for simplicity.

Those of ordinary skill in the art may be aware that the units and algorithm steps in the examples described with reference to the embodiments disclosed in this specification can be implemented by electronic hardware or a combination of computer software and electronic hardware. Whether the functions are performed by hardware or software depends on particular applications and design constraints of the technical solutions. A person skilled in the art may realize the described functions for each particular disclosure by different methods, but it is not be considered that the implementation is beyond the scope of the disclosure.

It may be clearly understood by a person skilled in the art that, for the purpose of convenient and brief description, for a detailed working process of the foregoing system, apparatus, and unit, reference may be made to a corresponding process in the foregoing method embodiments, and details are not described again herein.

In the several embodiments provided in the disclosure, it is to be understood that the disclosed system, apparatus, and method may be implemented in other manners. For example, the apparatus embodiment described above is only schematic, and for example, division of the units is only logic function division, and other division manners may be adopted during practical implementation. For example, multiple units or components may be combined or integrated into another system, or some characteristics may be neglected or not executed. In addition, the displayed or discussed mutual couplings or direct couplings or communication connections may be implemented by the indirect couplings or communication connections through some interfaces, apparatuses or units, which may be in electrical, mechanical or other forms.

The units described as separate components may or may not be physically separated, and the components displayed as units may or may not be physical units, and may be located in one place or may be distributed over multiple network units. Some or all of the units may be selected according to actual needs to achieve the objectives of the solutions of the embodiments.

In addition, functional units in various embodiments of the disclosure may be integrated into one processing unit, or each of the units may be physically separated, or two or more units may be integrated into one unit.

When the functions are realized in a form of a software functional unit and sold or used as an independent product, they may be stored in a computer-readable storage medium. Based on this understanding, the technical solutions of the embodiments of the disclosure essentially or the parts that contribute to the prior art, or part of the technical solutions can be embodied in the form of a software product. The computer software product is stored in a storage medium, including multiple instructions for causing a computer device (which may be a personal computer, a server, or a network device, or the like) to execute all or part of the operations of the methods described in the embodiments of the disclosure. The foregoing storage medium includes various media that can store program codes, such as a USB flash disk, a mobile hard disk drive, a ROM, a RAM, a magnetic disk or an optical disk.

The above descriptions are merely specific implementations of the disclosure, but are not intended to limit the scope of protection of the disclosure. Any variation or replacement readily figured out by a person skilled in the art within the technical scope disclosed in the disclosure shall fall within the scope of protection of the disclosure. Therefore, the scope of protection of the disclosure shall be subject to the scope of protection of the claims.

1. A data transmission method, comprising:
determining, by a terminal device, at least one first Transmission Configuration Indicator (TCI) state for a first Physical Downlink Control Channel (PDCCH), wherein the at least one first TCI state is used for indicating Quasi Co-Location (QCL) information of at least one PDCCH candidate of a plurality of PDCCH candidates, and the plurality of PDCCH candidates are used for transmitting/repeatedly transmitting the first PDCCH; and
receiving, by the terminal device, the first PDCCH based on the at least one first TCI state.

2. The method of claim 1, further comprising:
receiving, by the terminal device, first indication information sent by a network device, wherein the first indication information is used for indicating at least one TCI state of a plurality of available TCI states, and the at least one TCI state comprises the at least one first TCI state.

3. The method of claim 1, wherein the plurality of PDCCH candidates are PDCCH candidates in a plurality of search spaces, respectively, and a linking relationship exists among the plurality of search spaces.

4. The method of claim 3, wherein a number of the at least one first TCI state comprises one, and receiving, by the terminal device, the first PDCCH based on the at least one first TCI state comprises:
receiving, by the terminal device, the first PDCCH through the PDCCH candidates respectively corresponding to the plurality of search spaces, wherein the QCL information of a PDCCH candidate corresponding to each of the plurality of search spaces is determined by the first TCI state.

5. The method of claim 3, wherein a number of the at least one first TCI state comprises a plurality, and receiving, by the terminal device, the first PDCCH based on the at least one first TCI state comprises:
receiving, by the terminal device, the first PDCCH through the plurality of PDCCH candidates, wherein QCL information of the plurality of PDCCH candidates is determined by the plurality of first TCI states.

6. The method of claim 2, wherein the first indication information is carried through any one of:
a RRC signaling, a MAC CE signaling, or Downlink Control Information (DCI).

7. The method of claim 1, further comprising:
receiving, by the terminal device, seventh indication information sent by a network device, wherein the seventh indication information is used for indicating that a type of a unified TCI state is a joint TCI state, and the at least one first TCI state is the joint TCI state;
or,
receiving, by the terminal device, eighth indication information sent by a network device, wherein the eighth indication information is used for indicating that a type of a unified TCI state is a separate TCI state, and the at least one first TCI state is a DL TCI state.

8. The method of claim 1, further comprising:
sending, by the terminal device, first capability information and/or second capability information to a network device,
wherein the first capability information is used for indicating that the terminal device supports a plurality of unified TCI states to be simultaneously used for DL transmission, and/or that the terminal device supports a codepoint in a DCI to indicate a plurality of unified TCI states for DL transmission;
the second capability information is used for indicating that the terminal device supports PDCCH repetition, and/or that the terminal device supports linking among a plurality of search spaces, wherein
the first capability information and/or the second capability information are capabilities for any one of the following objects:
the terminal device;
a carrier;
a band;
a band combination;
a band combination and a band in the band combination;
a band combination and a carrier per band in the band combination; or
a frequency range.

9. A terminal device, comprising:
a transceiver;
a processor; and
a memory for storing a computer program that, when executed by the processor, causes the processor to:
determine at least one first Transmission Configuration Indicator (TCI) state for a first Physical Downlink Control Channel (PDCCH), wherein the at least one first TCI state is used for indicating Quasi Co-Location (QCL) information of at least one PDCCH candidate of a plurality of PDCCH candidates, and the plurality of PDCCH candidates are used for transmitting/repeatedly transmitting the first PDCCH; and
receive, via the transceiver, the first PDCCH based on the at least one first TCI state.

10. The terminal device of claim 9, wherein the processor is further configured to:
receive, via the transceiver, second indication information sent by a network device, wherein the second indication information is used for configuring a plurality of available TCI states, and the plurality of available TCI states comprise the at least one first TCI state.

11. The terminal device of claim 10, wherein the plurality of PDCCH candidates are PDCCH candidates in a plurality of search spaces, respectively, and a linking relationship exists among the plurality of search spaces, wherein the plurality of search spaces correspond to a plurality of Control Resource Sets (CORESETs).

12. The terminal device of claim 11, wherein the at least one first TCI state is used for indicating QCL information of PDCCH candidate(s) corresponding to at least one CORESET of the plurality of CORESETs.

13. The terminal device of claim 11, wherein a number of the at least one first TCI state comprises a plurality, and the processor is further configured to:
receive, via the transceiver, the first PDCCH through the plurality of PDCCH candidates, wherein QCL information of the plurality of PDCCH candidates is determined by the plurality of first TCI states.

14. The terminal device of claim 13, wherein the processor is further configured to perform any one of:
determining a first TCI state corresponding to a PDCCH candidate in each of the plurality of search spaces based on a size order of search space IDs of the plurality of search spaces and a size order of IDs of the plurality of first TCI states;
determining the first TCI state corresponding to the PDCCH candidate in each of the plurality of search spaces based on the size order of the search space IDs of the plurality of search spaces and positions of the plurality of first TCI states in the second indication information;
determining a first TCI state corresponding to a PDCCH candidate in each of the plurality of CORESETs based on a size order of CORESET IDs of the plurality of CORESETs and the size order of the IDs of the plurality of first TCI states;
determining the first TCI state corresponding to the PDCCH candidate in each of the plurality of CORESETs based on the size order of the CORESET IDs of the plurality of CORESETs and the positions of the plurality of first TCI states in the second indication information;
determining correspondences between the plurality of PDCCH candidates and the plurality of first TCI states based on fifth indication information sent by the network device; or
determining the first TCI states corresponding to the plurality of PDCCH candidates, respectively, based on a plurality of pieces of sixth indication information sent by the network device, with the plurality of pieces of sixth indication information being associated with the plurality of PDCCH candidates.

15. The terminal device of claim 14, wherein each piece of sixth indication information is carried through configuration information of a search space for a PDCCH associated with the sixth indication information, or carried through configuration information of a CORESET corresponding to a search space for a PDCCH associated with the sixth indication information.

16. The terminal device of claim 10, wherein the second indication information is carried through a first MAC CE signaling,
wherein the first MAC CE signaling comprises at least one of:
Downlink (DL) Bandwidth Part (BWP) indication information;
Uplink (UL) BWP indication information;
at least one TCI number indication information, wherein each of the at least one TCI number indication information is used for indicating a number of TCI states associated with the TCI number indication information;
at least one TCI type indication information, for indicating types of the plurality of available TCI states; or
configuration information of the plurality of available TCI states.

17. A network device, comprising:
a transceiver;
a processor; and
a memory for storing a computer program that, when executed by the processor, causes the processor to:
transmit, via the transceiver, a first Physical Downlink Control Channel (PDCCH) to a terminal device through at least one PDCCH candidate of a plurality of PDCCH candidates, wherein the plurality of PDCCH candidates are used for transmitting/repeatedly transmitting the first PDCCH, and Quasi Co-Location (QCL) information of the at least one PDCCH candidate is determined by at least one first Transmission Configuration Indicator (TCI) state for the first PDCCH.

18. The network device of claim 17, wherein the plurality of PDCCH candidates are PDCCH candidates in a plurality of search spaces, respectively, and a linking relationship exists among the plurality of search spaces.

19. The network device of claim 18, wherein a number of the at least one first TCI state comprises one, and the processor is further configured to:
receive, via the transceiver, the first PDCCH through the PDCCH candidates respectively corresponding to the plurality of search spaces, wherein the QCL information of a PDCCH candidate corresponding to each of the plurality of search spaces is determined by the first TCI state.

20. The network device of claim 18, wherein a number of the at least one first TCI state comprises a plurality, and the processor is further configured to:
receive, via the transceiver, the first PDCCH through the plurality of PDCCH candidates, wherein QCL information of the plurality of PDCCH candidates is determined by the plurality of first TCI states.
